(19) United States
(12) Patent Application Publication
(10) Pub. No.: US 2025/0138289 A1
(43) Pub. Date: May 1, 2025

(54) OPTICAL SYSTEM, OPTICAL DEVICE, AND METHOD FOR MANUFACTURING OPTICAL SYSTEM

(71) Applicant: NIKON CORPORATION, Tokyo (JP)

(72) Inventor: Takamichi KURASHIGE, Tokyo (JP)

(21) Appl. No.: 19/011,459

(22) Filed: Jan. 6, 2025

Related U.S. Application Data
(63) Continuation of application No. PCT/JP2023/025109, filed on Jul. 6, 2023.

(30) Foreign Application Priority Data
Jul. 7, 2022 (JP) 2022-109886

(51) Int. Cl. G02B 13/00; G02B 27/10; G02B 27/12; G02B 27/16

(52) U.S. Cl. CPC G02B 13/0065; G02B 13/006; G02B 13/008; G02B 27/1006; G02B 27/126; G02B 27/16

(57) ABSTRACT

An optical system including first and second optical systems satisfies the conditional expression below. The first optical system includes a front lens group, an optical path splitter with a splitting plane, and a first rear lens group on which one of two split parts of light is incident. The second optical system includes the front lens group, the optical path splitter, and a second rear lens group on which the other split part of light is incident. The total optical length of the first optical system is equal to or greater than that of the second optical system.

0.50<T(gr1)/(−f(gr1))<4.50

where T(gr1) is the distance on the optical axis from a lens surface closest to the object side in the front lens group to a lens surface closest to an image plane in the front lens group; f(gr1) is the combined focal length of the front lens group.

### CROSS-REFERENCE TO RELATED APPLICATIONS

This application is a continuation of International Patent Application No. PCT/JP2023/025109 filed Jul. 6, 2023, which claims priority from Japanese Patent Application No. 2022-109886 filed Jul. 7, 2022, and which are incorporated herein by reference.

### FIELD

The present disclosure relates to an optical system, an optical device, and a method for manufacturing an optical system.

### BACKGROUND

A proposed optical system divides incident light into first light and second light, and emits them (see, e.g., Japanese Unexamined Patent Publication No. 2006-324810).

### SUMMARY

An optical system of the present disclosure includes first and second optical systems. The first optical system includes, in order from an object side, a front lens group, an optical path splitter with a splitting plane that transmits a first part of incident light and that reflects at least a second part of the incident light different from the first part, and a first rear lens group on which one of the transmitted light and the reflected light is incident. The second optical system includes, in order from the object side, the front lens group, the optical path splitter, and a second rear lens group on which the other of the transmitted light and the reflected light is incident. The optical system satisfies the following conditional expression.

$$0.50 < T ( g r 1 ) / ( - f ( g r 1 ) ) < 4.50 \qquad ( 18 )$$

where
T(gr1): the distance on the optical axis from a lens surface closest to the object side in the front lens group to a lens surface closest to an image plane in the front lens group
f(gr1): the combined focal length of the front lens group

An optical system of the present disclosure includes first and second optical systems. The first optical system includes, in order from an object side, a front lens group, a prism with a splitting plane that transmits a first part of incident light and that reflects at least a second part of the incident light different from the first part, and a first rear lens group on which one of the transmitted light and the reflected light is incident. The second optical system includes, in order from the object side, the front lens group, the prism, and a second rear lens group on which the other of the transmitted light and the reflected light is incident. The first optical system has a greater total optical length than the second optical system. The optical system satisfies the conditional expressions below. A total optical length in the present disclosure refers to the sum of the distance on the optical axis from a lens surface closest to the object side to a lens surface closest to the image plane and a back focal length in air.

$$1.10 < T ( g r 1 ) / f ( fL ) < 5 \text{.20} \qquad ( 20 )$$

$$1. < T ( pfL ) / f ( fL ) < 11.50 \qquad ( 21 )$$

where
T(gr1): the distance on the optical axis from a lens surface closest to the object side in the front lens group to a lens surface closest to an image plane in the front lens group
f(fL): the longer of the focal lengths of the first and second optical systems
T(pfL): the length on the optical axis of the prism in the first or second optical system with a longer focal length

An optical system of the present disclosure includes first and second optical systems. The first optical system includes, in order from an object side, a front lens group, a prism with a splitting plane that transmits a first part of incident light and that reflects at least a second part of the incident light different from the first part, and a first rear lens group on which one of the transmitted light and the reflected light is incident. The second optical system includes, in order from the object side, the front lens group, the prism, and a second rear lens group on which the other of the transmitted light and the reflected light is incident. The first optical system has a greater total optical length than the second optical system. The optical system satisfies the following conditional expressions.

$$2.50 < T ( g r 1 ) / f ( fS ) < 9 \text{.50} \qquad ( 22 )$$

$$3. < T ( pfS ) / f ( fS ) < 20.00 \qquad ( 23 )$$

where
T(gr1): the distance on the optical axis from a lens surface closest to the object side in the front lens group to a lens surface closest to an image plane in the front lens group
f(fS): the shorter of the focal lengths of the first and second optical systems
T(pfS): the length on the optical axis of the prism in the first or second optical system with a shorter focal length

A method for manufacturing an optical system of the present disclosure is a method for manufacturing an optical system including first and second optical systems. The first optical system includes, in order from an object side, a front lens group, an optical path splitter with a splitting plane that transmits a first part of incident light and that reflects at least a second part of the incident light different from the first part, and a first rear lens group on which one of the transmitted light and the reflected light is incident. The second optical system includes, in order from the object side, the front lens group, the optical path splitter, and a second rear lens group on which the other of the transmitted light and the reflected light is incident. The total optical length of the first optical system is equal to or greater than the total optical length of the second optical system. The method includes disposing the lens groups and the optical path splitter so as to satisfy the following conditional expression.

$$0.50 < T ( g r 1 ) / ( - f ( g r 1 ) ) < 4.50 \qquad ( 18 )$$

where
T(gr1): the distance on the optical axis from a lens surface closest to the object side in the front lens group to a lens surface closest to an image plane in the front lens group
f(gr1): the combined focal length of the front lens group

### BRIEF DESCRIPTION OF DRAWINGS

FIG. 1 schematically shows the configuration of an optical system of a first example.

FIG. 2 is a cross-sectional view of a first optical system included in the optical system of the first example.

FIG. 3 shows aberrations of the first optical system included in the optical system of the first example.

FIG. 4 is a cross-sectional view of a second optical system included in the optical system of the first example.

FIG. 5 shows aberrations of the second optical system included in the optical system of the first example.

FIG. 6 is a cross-sectional view of a first optical system included in an optical system of a second example.

FIG. 7 shows aberrations of the first optical system included in the optical system of the second example.

FIG. 8 is a cross-sectional view of a second optical system included in the optical system of the second example.

FIG. 9 shows aberrations of the second optical system included in the optical system of the second example.

FIG. 10 is a cross-sectional view of a first optical system included in an optical system of a third example.

FIG. 11 shows aberrations of the first optical system included in the optical system of the third example.

FIG. 12 is a cross-sectional view of a second optical system included in the optical system of the third example.

FIG. 13 shows aberrations of the second optical system included in the optical system of the third example.

FIG. 14 schematically shows the configuration of an optical system of a fourth example.

FIG. 15 is a cross-sectional view of a first optical system included in the optical system of the fourth example.

FIG. 16 shows aberrations of the first optical system included in the optical system of the fourth example.

FIG. 17 is a cross-sectional view of a second optical system included in the optical system of the fourth example.

FIG. 18 shows aberrations of the second optical system included in the optical system of the fourth example.

FIG. 19 schematically shows the configuration of an optical system of a fifth example.

FIG. 20 is a cross-sectional view of a first optical system included in the optical system of the fifth example.

FIG. 21 shows aberrations of the first optical system included in the optical system of the fifth example.

FIG. 22 is a cross-sectional view of a second optical system included in the optical system of the fifth example.

FIG. 23 shows aberrations of the second optical system included in the optical system of the fifth example.

FIG. 24 schematically shows an optical apparatus including an optical system of the embodiment.

FIG. 25 is a flowchart outlining a method for manufacturing an optical system of the embodiment.

### DESCRIPTION OF EMBODIMENTS

The following describes an optical system, an optical apparatus, and a method for manufacturing an optical system of an embodiment of the present application.

An optical system of the present embodiment includes first and second optical systems. The first optical system includes, in order from an object side, a front lens group, an optical path splitter with a splitting plane that transmits a first part of incident light and that reflects at least a second part of the incident light different from the first part, and a first rear lens group on which one of the transmitted light and the reflected light is incident. The second optical system includes, in order from the object side, the front lens group, the optical path splitter, and a second rear lens group on which the other of the transmitted light and the reflected light is incident. The optical system satisfies the following conditional expression.

$$0.50 < T ( g r 1 ) / ( - f ( g r 1 ) ) < 4.50 \qquad ( 18 )$$

where
T(gr1): the distance on the optical axis from a lens surface closest to the object side in the front lens group to a lens surface closest to an image plane in the front lens group
f(gr1): the combined focal length of the front lens group

The whole optical system of the present embodiment can be downsized by using a front lens group in the first and second optical systems.

Conditional expression (18) restricts the ratio of the distance on the optical axis from a lens surface closest to the object side in the front lens group to a lens surface closest to an image plane in the front lens group to the combined focal length of the front lens group. The optical system of the present embodiment, which satisfies conditional expression (18), can avoid the lens closest to the object side having to have a large diameter, avoid the first and second optical systems having to have a long total optical length, and correct aberrations, such as curvature of field and distortion, appropriately.

If the value of conditional expression (18) exceeds the upper limit in the optical system of the present embodiment, the diameter of the lens closest to the object side will be too large and it will be difficult to correct aberrations, such as curvature of field, astigmatism, and distortion.

In the optical system of the present embodiment, the effect of the present embodiment can be ensured by setting the upper limit of conditional expression (18) to 4.50. To further ensure the effect of the present embodiment, the upper limit of conditional expression (18) is preferably set to 3.80 or 3.20, more preferably to 2.60.

If the value of conditional expression (18) is below the lower limit in the optical system of the present embodiment, the diameter of the lens closest to the object side will be too large and it will be difficult to correct aberrations, such as curvature of field and distortion.

In the optical system of the present embodiment, the effect of the present embodiment can be ensured by setting the lower limit of conditional expression (18) to 0.50. To further ensure the effect of the present embodiment, the lower limit of conditional expression (18) is preferably set to 0.70 or 0.90, more preferably to 1.00.

The optical system of the present embodiment preferably satisfies the following conditional expression.

$$0.80 < T ( g r 1 ) / ( - f ( g r 1 n ) ) < 4.60 \qquad ( 19 )$$

where
f(gr1n): the combined focal length of a negative lens disposed closest to the object side of negative lenses in the front lens group and one or more negative lenses disposed next to the negative lens on the image plane side

Conditional expression (19) restricts the ratio of the distance on the optical axis from a lens surface closest to the object side in the front lens group to a lens surface closest to an image plane in the front lens group to the combined focal length of a negative lens disposed closest to the object side of negative lenses in the front lens group and one or more negative lenses disposed next to the negative lens on the image plane side. The optical system of the present embodiment, which satisfies conditional expression (19), can avoid the lens closest to the object side having to have a large diameter, avoid the first optical system having to have a long total optical length, and correct aberrations, such as curvature of field and distortion, appropriately.

If the value of conditional expression (19) exceeds the upper limit in the optical system of the present embodiment, the total optical length of the first optical system will be too long and it will be difficult to correct aberrations, such as curvature of field and distortion.

In the optical system of the present embodiment, the effect of the present embodiment can be ensured by setting the upper limit of conditional expression (19) to 4.60. To further ensure the effect of the present embodiment, the upper limit of conditional expression (19) is preferably set to 3.80 or 3.10, more preferably to 2.40.

If the value of conditional expression (19) is below the lower limit in the optical system of the present embodiment, the diameter of the lens closest to the object side will be too large and it will be difficult to correct aberrations, such as curvature of field and distortion.

In the optical system of the present embodiment, the effect of the present embodiment can be ensured by setting the lower limit of conditional expression (19) to 0.80. To further ensure the effect of the present embodiment, the lower limit of conditional expression (19) is preferably set to 0.95 or 1.10, more preferably to 1.20.

The optical system of the present embodiment preferably satisfies the following conditional expression.

$$1.00 < T L ( L ) / TL ( s ) < 3.50 \qquad ( 26 )$$

where
TL(L): the total optical length of the first optical system
TL(S): the total optical length of the second optical system

Conditional expression (26) restricts the ratio between the total optical lengths of the first and second optical systems. The optical system of the present embodiment, which satisfies conditional expression (26), can avoid the first optical system having to have a long total optical length and correct aberrations, such as spherical aberration and coma aberration, appropriately.

If the value of conditional expression (26) exceeds the upper limit in the optical system of the present embodiment, the total optical length of the first optical system will be too long and it will be difficult to correct aberrations, such as spherical aberration and coma aberration.

In the optical system of the present embodiment, the effect of the present embodiment can be ensured by setting the upper limit of conditional expression (26) to 3.50. To further ensure the effect of the present embodiment, the upper limit of conditional expression (26) is preferably set to 2.80 or 2.20, more preferably to 1.60.

An optical system of the present embodiment includes first and second optical systems. The first optical system includes, in order from an object side, a front lens group, a prism with a splitting plane that transmits a first part of incident light and that reflects at least a second part of the incident light different from the first part, and a first rear lens group on which one of the transmitted light and the reflected light is incident. The second optical system includes, in order from the object side, the front lens group, the prism, and a second rear lens group on which the other of the transmitted light and the reflected light is incident. The first optical system has a greater total optical length than the second optical system. The optical system satisfies the following conditional expressions.

$$1.10 < T ( g r 1 ) / f ( fL ) < 5 \text{.20} \qquad ( 20 )$$

$$1. < T ( p fL ) / f ( fL ) < 11.50 \qquad ( 21 )$$

where
T(gr1): the distance on the optical axis from a lens surface closest to the object side in the front lens group to a lens surface closest to an image plane in the front lens group
f(fL): the longer of the focal lengths of the first and second optical systems
T(pfL): the length on the optical axis of the prism in the first or second optical system with a longer focal length

The whole optical system of the present embodiment can be downsized by using a front lens group in the first and second optical systems.

Conditional expression (20) restricts the ratio of the distance on the optical axis from a lens surface closest to the object side in the front lens group to a lens surface closest to an image plane in the front lens group to the longer of the focal lengths of the first and second optical systems. The optical system of the present embodiment, which satisfies conditional expression (20), can avoid the lens closest to the object side having to have a large diameter, avoid the first or second optical system with a longer focal length having to have a long total optical length, and correct aberrations, such as curvature of field and distortion, appropriately.

If the value of conditional expression (20) exceeds the upper limit in the optical system of the present embodiment, the total optical length of the first or second optical system with a longer focal length will be too long and it will be difficult to correct aberrations, such as curvature of field and distortion.

In the optical system of the present embodiment, the effect of the present embodiment can be ensured by setting the upper limit of conditional expression (20) to 5.20. To further ensure the effect of the present embodiment, the upper limit of conditional expression (20) is preferably set to 4.70 or 4.20, more preferably to 3.80.

If the value of conditional expression (20) is below the lower limit in the optical system of the present embodiment, the diameter of the lens closest to the object side will be too large and it will be difficult to correct aberrations, such as curvature of field and distortion.

In the optical system of the present embodiment, the effect of the present embodiment can be ensured by setting the lower limit of conditional expression (20) to 1.10. To further ensure the effect of the present embodiment, the lower limit of conditional expression (20) is preferably set to 1.50 or 1.80, more preferably to 2.10.

Conditional expression (21) restricts the ratio of the length on the optical axis of the prism in the first or second optical system with a longer focal length to the longer of the focal lengths of the first and second optical systems. The optical system of the present embodiment, which satisfies conditional expression (21), can avoid the lens closest to the object side having to have a large diameter, avoid the first or second optical system with a longer focal length having to have a long total optical length, and correct aberrations, such as curvature of field and distortion, appropriately.

If the value of conditional expression (21) exceeds the upper limit in the optical system of the present embodiment, the total optical length of the first or second optical system with a longer focal length will be too long and it will be difficult to correct aberrations, such as curvature of field and distortion.

In the optical system of the present embodiment, the effect of the present embodiment can be ensured by setting the upper limit of conditional expression (21) to 11.50. To further ensure the effect of the present embodiment, the upper limit of conditional expression (21) is preferably set to 8.80 or 7.10, more preferably to 6.50.

If the value of conditional expression (21) is below the lower limit in the optical system of the present embodiment, it will be difficult to correct aberrations, such as curvature of field and distortion.

In the optical system of the present embodiment, the effect of the present embodiment can be ensured by setting the lower limit of conditional expression (21) to 1.00. To further ensure the effect of the present embodiment, the lower limit of conditional expression (21) is preferably set to 1.40 or 1.80, more preferably to 2.20.

An optical system of the present embodiment includes first and second optical systems. The first optical system includes, in order from an object side, a front lens group, a prism with a splitting plane that transmits a first part of incident light and that reflects at least a second part of the incident light different from the first part, and a first rear lens group on which one of the transmitted light and the reflected light is incident. The second optical system includes, in order from the object side, the front lens group, the prism, and a second rear lens group on which the other of the transmitted light and the reflected light is incident. The first optical system has a greater total optical length than the second optical system. The optical system satisfies the following conditional expressions.

$$2.50 < T ( g r 1 ) / f ( fS ) < 9 \text{.50} \qquad ( 22 )$$

$$3. < T ( pfS ) / f ( fS ) < 20.00 \qquad ( 23 )$$

where
T(gr1): the distance on the optical axis from a lens surface closest to the object side in the front lens group to a lens surface closest to an image plane in the front lens group
f(fS): the shorter of the focal lengths of the first and second optical systems
T(pfS): the length on the optical axis of the prism in the first or second optical system with a shorter focal length

The whole optical system of the present embodiment can be downsized by using a front lens group in the first and second optical systems.

Conditional expression (22) restricts the ratio of the distance on the optical axis from a lens surface closest to the object side in the front lens group to a lens surface closest to an image plane in the front lens group to the shorter of the focal lengths of the first and second optical systems. The optical system of the present embodiment, which satisfies conditional expression (22), can avoid the first or second optical system with a shorter focal length having to have a long total optical length and correct aberrations, such as curvature of field and distortion, appropriately.

If the value of conditional expression (22) exceeds the upper limit in the optical system of the present embodiment, the total optical length of the first or second optical system with a shorter focal length will be too long and it will be difficult to correct aberrations, such as curvature of field and distortion.

In the optical system of the present embodiment, the effect of the present embodiment can be ensured by setting the upper limit of conditional expression (22) to 9.50. To further ensure the effect of the present embodiment, the upper limit of conditional expression (22) is preferably set to 8.60 or 7.70, more preferably to 6.80.

If the value of conditional expression (22) is below the lower limit in the optical system of the present embodiment, the diameter of the lens closest to the object side will be too large and it will be difficult to correct aberrations, such as curvature of field and distortion.

In the optical system of the present embodiment, the effect of the present embodiment can be ensured by setting the lower limit of conditional expression (22) to 2.50. To further ensure the effect of the present embodiment, the lower limit of conditional expression (22) is preferably set to 3.00 or 3.50, more preferably to 3.90.

Conditional expression (23) restricts the ratio of the length on the optical axis of the prism in the first or second optical system with a shorter focal length to the shorter of the focal lengths of the first and second optical systems. The optical system of the present embodiment, which satisfies conditional expression (23), can avoid the first or second optical system with a shorter focal length having to have a long total optical length and correct aberrations, such as curvature of field and distortion, appropriately.

If the value of conditional expression (23) exceeds the upper limit in the optical system of the present embodiment, the total optical length of the first or second optical system with a shorter focal length will be too long and it will be difficult to correct aberrations, such as curvature of field and distortion.

In the optical system of the present embodiment, the effect of the present embodiment can be ensured by setting the upper limit of conditional expression (23) to 20.00. To further ensure the effect of the present embodiment, the upper limit of conditional expression (23) is preferably set to 19.00 or 18.00, more preferably to 17.00.

If the value of conditional expression (23) is below the lower limit in the optical system of the present embodiment, it will be difficult to correct aberrations, such as curvature of field and distortion.

In the optical system of the present embodiment, the effect of the present embodiment can be ensured by setting the lower limit of conditional expression (23) to 3.00. To further ensure the effect of the present embodiment, the lower limit of conditional expression (23) is preferably set to 3.40 or 3.80, more preferably to 4.20.

The optical system of the present embodiment preferably satisfies the following conditional expression.

$$1.10 < T ( pL ) / T ( pS ) < 5.50 \qquad ( 2 )$$

where
T(pL): the length on the optical axis of the prism in the first optical system
T(pS): the length on the optical axis of the prism in the second optical system

Conditional expression (2) restricts the ratio between the lengths on the optical axis of the prism in the first and second optical systems. The optical system of the present embodiment, which satisfies conditional expression (2), can correct aberrations, such as spherical aberration and coma aberration, appropriately and ensure enough peripheral light.

If the value of conditional expression (2) exceeds the upper limit in the optical system of the present embodiment, it will be difficult to correct aberrations, such as spherical aberration and coma aberration.

In the optical system of the present embodiment, the effect of the present embodiment can be ensured by setting the upper limit of conditional expression (2) to 5.50. To further ensure the effect of the present embodiment, the upper limit of conditional expression (2) is preferably set to 4.70 or 3.80, more preferably to 3.00.

If the value of conditional expression (2) is below the lower limit in the optical system of the present embodiment, it will be difficult to correct aberrations, such as spherical aberration and coma aberration. Further, peripheral luminous flux of the first optical system will be limited and the amount of peripheral light will be reduced.

In the optical system of the present embodiment, the effect of the present embodiment can be ensured by setting the lower limit of conditional expression (2) to 1.10. To further ensure the effect of the present embodiment, the lower limit of conditional expression (2) is preferably set to 1.60 or 2.10, more preferably to 2.60.

The optical system of the present embodiment preferably satisfies the following conditional expression.

$$1.20 < T ( pS ) / f ( S ) < 6.40 \qquad ( 12 )$$

where
T(pS): the length on the optical axis of the prism in the second optical system
f(S): the focal length of the second optical system

Conditional expression (12) restricts the ratio of the length on the optical axis of the prism in the second optical system to the focal length of the second optical system. The optical system of the present embodiment, which satisfies conditional expression (12), can avoid the second optical system having to have a long total optical length and correct aberrations, such as spherical aberration, coma aberration, and curvature of field, appropriately.

If the value of conditional expression (12) exceeds the upper limit in the optical system of the present embodiment, the total optical length will be too long and it will be difficult to correct aberrations, such as spherical aberration, coma aberration, and curvature of field, in the second optical system.

In the optical system of the present embodiment, the effect of the present embodiment can be ensured by setting the upper limit of conditional expression (12) to 6.40. To further ensure the effect of the present embodiment, the upper limit of conditional expression (12) is preferably set to 5.70 or 5.00, more preferably to 4.40.

If the value of conditional expression (12) is below the lower limit in the optical system of the present embodiment, it will be difficult to correct aberrations, such as spherical aberration, coma aberration, and curvature of field, in the second optical system.

In the optical system of the present embodiment, the effect of the present embodiment can be ensured by setting the lower limit of conditional expression (12) to 1.20. To further ensure the effect of the present embodiment, the lower limit of conditional expression (12) is preferably set to 1.50 or 1.80, more preferably to 2.20.

The optical system of the present embodiment preferably satisfies the following conditional expression.

$$2.40 < T ( pL ) / f ( L ) < 20.50 \qquad ( 13 )$$

where
T(pL): the length on the optical axis of the prism in the first optical system
f(L): the focal length of the first optical system

Conditional expression (13) restricts the ratio of the length on the optical axis of the prism in the first optical system to the focal length of the first optical system. The optical system of the present embodiment, which satisfies conditional expression (13), can avoid the first optical system having to have a long total optical length and correct aberrations, such as spherical aberration, coma aberration, and curvature of field, appropriately.

If the value of conditional expression (13) exceeds the upper limit in the optical system of the present embodiment, the total optical length will be too long and it will be difficult to correct aberrations, such as spherical aberration, coma aberration, and curvature of field, in the first optical system.

In the optical system of the present embodiment, the effect of the present embodiment can be ensured by setting the upper limit of conditional expression (13) to 20.50. To further ensure the effect of the present embodiment, the upper limit of conditional expression (13) is preferably set to 19.00 or 17.50, more preferably to 16.50.

If the value of conditional expression (13) is below the lower limit in the optical system of the present embodiment, it will be difficult to correct aberrations, such as spherical aberration, coma aberration, and curvature of field, in the first optical system.

In the optical system of the present embodiment, the effect of the present embodiment can be ensured by setting the lower limit of conditional expression (13) to 2.40. To further ensure the effect of the present embodiment, the lower limit of conditional expression (13) is preferably set to 3.20 or 4.00, more preferably to 4.80.

In the optical system of the present embodiment, the prism preferably includes a total reflection surface that totally reflects at least light on the optical axis, out of light reflected by the splitting plane after passing through the front lens group.

In the optical system of the present embodiment, the total reflection surface enables reduction in the angle of incidence of incident light on the splitting plane and the degree of difficulty in making a splitting plane of predetermined performance.

The optical system of the present embodiment preferably satisfies the following conditional expression.

$$1.40 < T ( gr 1 ) / f ( S ) < 6.90 \qquad ( 14 )$$

where
T(gr1): the distance on the optical axis from a lens surface closest to the object side in the front lens group to a lens surface closest to an image plane in the front lens group
f(S): the focal length of the second optical system

Conditional expression (14) restricts the ratio of the distance on the optical axis from a lens surface closest to the object side in the front lens group to a lens surface closest to an image plane in the front lens group to the focal length of the second optical system. The optical system of the present embodiment, which satisfies conditional expression (14), can avoid the second optical system having to have a long total optical length and correct aberrations, such as spherical aberration, coma aberration, and curvature of field, appropriately.

If the value of conditional expression (14) exceeds the upper limit in the optical system of the present embodiment, the total optical length will be too long and it will be difficult to correct aberrations, such as spherical aberration, coma aberration, and curvature of field, in the second optical system.

In the optical system of the present embodiment, the effect of the present embodiment can be ensured by setting the upper limit of conditional expression (14) to 6.90. To further ensure the effect of the present embodiment, the upper limit of conditional expression (14) is preferably set to 6.30 or 5.70, more preferably to 5.10.

If the value of conditional expression (14) is below the lower limit in the optical system of the present embodiment, it will be difficult to correct aberrations, such as spherical aberration, coma aberration, and curvature of field, in the second optical system.

In the optical system of the present embodiment, the effect of the present embodiment can be ensured by setting the lower limit of conditional expression (14) to 1.40. To further ensure the effect of the present embodiment, the lower limit of conditional expression (14) is preferably set to 1.90 or 2.40, more preferably to 2.80.

The optical system of the present embodiment preferably satisfies the following conditional expression.

$$1.00 < T ( gr 1 ) / f ( L ) < 9.80 \qquad ( 15 )$$

where
T(gr1): the distance on the optical axis from a lens surface closest to the object side in the front lens group to a lens surface closest to an image plane in the front lens group
f(L): the focal length of the first optical system

Conditional expression (15) restricts the ratio of the distance on the optical axis from a lens surface closest to the object side in the front lens group to a lens surface closest to an image plane in the front lens group to the focal length of the first optical system. The optical system of the present embodiment, which satisfies conditional expression (15), can avoid the first optical system having to have a long total optical length and correct aberrations, such as spherical aberration, coma aberration, and curvature of field, appropriately.

If the value of conditional expression (15) exceeds the upper limit in the optical system of the present embodiment, the total optical length will be too long and it will be difficult to correct aberrations, such as spherical aberration, coma aberration, and curvature of field, in the first optical system.

In the optical system of the present embodiment, the effect of the present embodiment can be ensured by setting the upper limit of conditional expression (15) to 9.80. To further ensure the effect of the present embodiment, the upper limit of conditional expression (15) is preferably set to 8.80 or 7.80, more preferably to 6.80.

If the value of conditional expression (15) is below the lower limit in the optical system of the present embodiment, it will be difficult to correct aberrations, such as spherical aberration, coma aberration, and curvature of field, in the first optical system.

In the optical system of the present embodiment, the effect of the present embodiment can be ensured by setting the lower limit of conditional expression (15) to 1.00. To further ensure the effect of the present embodiment, the lower limit of conditional expression (15) is preferably set to 1.40 or 1.80, more preferably to 2.10.

The optical system of the present embodiment preferably satisfies the following conditional expression.

$$0.8 < - f ( gr 1 n ) / f ( L ) < 4.30 \qquad ( 1 )$$

where
f(gr1n): the combined focal length of a negative lens disposed closest to the object side of negative lenses in the front lens group and one or more negative lenses disposed next to the negative lens on the image plane side
f(L): the focal length of the first optical system

Conditional expression (1) restricts the ratio of the combined focal length of a negative lens disposed closest to the object side of negative lenses in the front lens group and one or more negative lenses disposed next to the negative lens on the image plane side to the focal length of the first optical system. The optical system of the present embodiment, which satisfies conditional expression (1), can avoid the lens closest to the object side having to have a large diameter and correct aberrations, such as curvature of field, astigmatism, and distortion, appropriately.

If the value of conditional expression (1) exceeds the upper limit in the optical system of the present embodiment, the diameter of the lens closest to the object side will be too large and it will be difficult to correct aberrations, such as curvature of field, astigmatism, and distortion.

In the optical system of the present embodiment, the effect of the present embodiment can be ensured by setting the upper limit of conditional expression (1) to 4.30. To further ensure the effect of the present embodiment, the upper limit of conditional expression (1) is preferably set to 3.80 or 3.35, more preferably to 2.90.

If the value of conditional expression (1) is below the lower limit in the optical system of the present embodiment, the total optical length of the second optical system will be too long and it will be difficult to correct aberrations, such as spherical aberration and coma aberration. Further, peripheral luminous flux of the first optical system will be limited and the amount of peripheral light will be reduced.

In the optical system of the present embodiment, the effect of the present embodiment can be ensured by setting the lower limit of conditional expression (1) to 0.80. To further ensure the effect of the present embodiment, the lower limit of conditional expression (1) is preferably set to 1.10 or 1.40, more preferably to 1.70.

The optical system of the present embodiment preferably satisfies the following conditional expression.

$$0.5 < - f ( gr 1 n ) / f ( S ) < 4.40 \qquad ( 3 )$$

where
f(S): the focal length of the second optical system

Conditional expression (3) restricts the ratio of the combined focal length of a negative lens disposed closest to the object side of negative lenses in the front lens group and one or more negative lenses disposed next to the negative lens on the image plane side to the focal length of the second optical system. The optical system of the present embodiment, which satisfies conditional expression (3), can avoid the lens closest to the object side having to have a large diameter and correct aberrations, such as curvature of field, astigmatism, and distortion, appropriately.

If the value of conditional expression (3) exceeds the upper limit in the optical system of the present embodiment, the diameter of the lens closest to the object side will be too large and it will be difficult to correct aberrations, such as curvature of field, astigmatism, and distortion.

In the optical system of the present embodiment, the effect of the present embodiment can be ensured by setting the upper limit of conditional expression (3) to 4.40. To further ensure the effect of the present embodiment, the upper limit of conditional expression (3) is preferably set to 4.00 or 3.70, more preferably to 3.40.

If the value of conditional expression (3) is below the lower limit in the optical system of the present embodiment, it will be difficult to correct aberrations, such as curvature of field, astigmatism, and distortion.

In the optical system of the present embodiment, the effect of the present embodiment can be ensured by setting the lower limit of conditional expression (3) to 0.50. To further ensure the effect of the present embodiment, the lower limit of conditional expression (3) is preferably set to 0.80 or 1.15, more preferably to 1.50.

Preferably, the second rear lens group includes an aperture stop, and the optical system of the present embodiment satisfies the following conditional expression.

$$0.50 < f ( gr 2 S ) / ( - f ( gr 1 ) ) < 3.40 \qquad ( 6 )$$

where
f(gr2S): the combined focal length of lenses in the second rear lens group closer to the image plane than the aperture stop
f(gr1): the combined focal length of the front lens group

Conditional expression (6) restricts the ratio of the combined focal length of lenses in the second rear lens group closer to the image plane than the aperture stop to the combined focal length of the front lens group. The optical system of the present embodiment, which satisfies conditional expression (6), can avoid the lens closest to the object side having to have a large diameter, avoid the second optical system having to have a long total optical length, and correct aberrations, such as curvature of field, coma aberration, and distortion, appropriately.

If the value of conditional expression (6) exceeds the upper limit in the optical system of the present embodiment, the lenses in the second optical system closer to the image plane than the aperture stop will have weak refractive power to cause the total optical length to be too long, and it will be difficult to correct aberrations, such as curvature of field, coma aberration, and distortion.

In the optical system of the present embodiment, the effect of the present embodiment can be ensured by setting the upper limit of conditional expression (6) to 3.40. To further ensure the effect of the present embodiment, the upper limit of conditional expression (6) is preferably set to 3.10 or 2.80, more preferably to 2.50.

If the value of conditional expression (6) is below the lower limit in the optical system of the present embodiment, the front lens group will have weak refractive power to cause the diameter of the lens closest to the object side to be too large, and it will be difficult to correct aberrations, such as curvature of field and distortion, in the second optical system.

In the optical system of the present embodiment, the effect of the present embodiment can be ensured by setting the lower limit of conditional expression (6) to 0.50. To further ensure the effect of the present embodiment, the lower limit of conditional expression (6) is preferably set to 0.65 or 0.80, more preferably to 0.95.

Preferably, the first rear lens group includes an aperture stop, and the optical system of the present embodiment satisfies the following conditional expression.

$$0.40 < f ( gr 2 L ) / ( - f ( gr 1 ) ) < 4.2 \qquad ( 7 )$$

where
f(gr2L): the combined focal length of lenses in the first rear lens group closer to the image plane than the aperture stop
f(gr1): the combined focal length of the front lens group

Conditional expression (7) restricts the ratio of the combined focal length of lenses in the first rear lens group closer to the image plane than the aperture stop to the combined focal length of the front lens group. The optical system of the present embodiment, which satisfies conditional expression (7), can avoid the lens closest to the object side having to have a large diameter, avoid the first optical system having to have a long total optical length, and correct aberrations, such as curvature of field, coma aberration, and distortion, appropriately.

If the value of conditional expression (7) exceeds the upper limit in the optical system of the present embodiment, the lenses in the first optical system closer to the image plane than the aperture stop will have weak refractive power to cause the total optical length to be too long, and it will be difficult to correct aberrations, such as curvature of field, coma aberration, and distortion.

In the optical system of the present embodiment, the effect of the present embodiment can be ensured by setting the upper limit of conditional expression (7) to 4.20. To further ensure the effect of the present embodiment, the upper limit of conditional expression (7) is preferably set to 3.80 or 3.50, more preferably to 3.20.

If the value of conditional expression (7) is below the lower limit in the optical system of the present embodiment, the front lens group will have weak refractive power to cause the diameter of the lens closest to the object side to be too large, and it will be difficult to correct aberrations, such as curvature of field and distortion, in the first optical system.

In the optical system of the present embodiment, the effect of the present embodiment can be ensured by setting the lower limit of conditional expression (7) to 0.40. To further ensure the effect of the present embodiment, the lower limit of conditional expression (7) is preferably set to 0.75 or 1.10, more preferably to 1.45.

The optical system of the present embodiment preferably satisfies the following conditional expression.

$$0.70 < f ( lS ) / ( - f ( gr 1 n ) ) < 5. 90 \qquad ( 8 )$$

where
f(lS): the focal length of a lens closest to the image plane in the second rear lens group

Conditional expression (8) restricts the ratio of the focal length of a lens closest to the image plane in the second rear lens group to the combined focal length of a negative lens disposed closest to the object side of negative lenses in the front lens group and one or more negative lenses disposed next to the negative lens on the image plane side. The optical system of the present embodiment, which satisfies conditional expression (8), can avoid the lens closest to the object side having to have a large diameter, avoid the second optical system having to have a long total optical length, and correct aberrations, such as curvature of field, coma aberration, and distortion, appropriately.

If the value of conditional expression (8) exceeds the upper limit in the optical system of the present embodiment, the lens closest to the image plane in the second optical system will have weak refractive power to cause the total optical length to be too long, and it will be difficult to correct aberrations, such as curvature of field, coma aberration, and distortion.

In the optical system of the present embodiment, the effect of the present embodiment can be ensured by setting the upper limit of conditional expression (8) to 5.90. To further ensure the effect of the present embodiment, the upper limit of conditional expression (8) is preferably set to 5.30 or 4.80, more preferably to 4.20.

If the value of conditional expression (8) is below the lower limit in the optical system of the present embodiment, the front lens group will have weak refractive power to cause the diameter of the lens closest to the object side to be too large, and it will be difficult to correct aberrations, such as curvature of field and distortion, in the second optical system.

In the optical system of the present embodiment, the effect of the present embodiment can be ensured by setting the lower limit of conditional expression (8) to 0.70. To further ensure the effect of the present embodiment, the lower limit of conditional expression (8) is preferably set to 1.00 or 1.35, more preferably to 1.70.

The optical system of the present embodiment preferably satisfies the following conditional expression.

$$1.50 < f ( lL ) / ( - f ( gr 1 n ) ) < 7.7 \qquad ( 9 )$$

where
f(lL): the focal length of a lens closest to the image plane in the first rear lens group

Conditional expression (9) restricts the ratio of the focal length of a lens closest to the image plane in the first rear lens group to the combined focal length of a negative lens disposed closest to the object side of negative lenses in the front lens group and one or more negative lenses disposed next to the negative lens on the image plane side. The optical system of the present embodiment, which satisfies conditional expression (9), can avoid the lens closest to the object side having to have a large diameter, avoid the first optical system having to have a long total optical length, and correct aberrations, such as curvature of field, coma aberration, and distortion, appropriately.

If the value of conditional expression (9) exceeds the upper limit in the optical system of the present embodiment, the lens closest to the image plane in the first optical system will have weak refractive power to cause the total optical length to be too long, and it will be difficult to correct aberrations, such as curvature of field, coma aberration, and distortion.

In the optical system of the present embodiment, the effect of the present embodiment can be ensured by setting the upper limit of conditional expression (9) to 7.70. To further ensure the effect of the present embodiment, the upper limit of conditional expression (9) is preferably set to 6.30 or 5.00, more preferably to 3.90.

If the value of conditional expression (9) is below the lower limit in the optical system of the present embodiment, the front lens group will have weak refractive power to cause the diameter of the lens closest to the object side to be too large, and it will be difficult to correct aberrations, such as curvature of field and distortion, in the first optical system.

In the optical system of the present embodiment, the effect of the present embodiment can be ensured by setting the lower limit of conditional expression (9) to 1.50. To further ensure the effect of the present embodiment, the lower limit of conditional expression (9) is preferably set to 1.70 or 1.90, more preferably to 2.10.

Preferably, the second rear lens group includes an aperture stop, and the optical system of the present embodiment satisfies the following conditional expression.

$$1.60 < f ( gr 2 S ) / f ( S ) < 5.60 \qquad ( 10 )$$

where
f(gr2S): the combined focal length of lenses in the second rear lens group closer to the image plane than the aperture stop
f(S): the focal length of the second optical system

Conditional expression (10) restricts the ratio of the combined focal length of lenses in the second rear lens group closer to the image plane than the aperture stop to the focal length of the second optical system. The optical system of the present embodiment, which satisfies conditional expression (10), can avoid the second optical system having to have a long total optical length and correct aberrations, such as spherical aberration, coma aberration, and curvature of field, appropriately.

If the value of conditional expression (10) exceeds the upper limit in the optical system of the present embodiment, the lenses in the second optical system closer to the image plane than the aperture stop will have weak refractive power to cause the total optical length to be too long, and it will be difficult to correct aberrations, such as spherical aberration, coma aberration, and curvature of field.

In the optical system of the present embodiment, the effect of the present embodiment can be ensured by setting the upper limit of conditional expression (10) to 5.60. To further ensure the effect of the present embodiment, the upper limit of conditional expression (10) is preferably set to 5.00 or 4.50, more preferably to 3.90.

If the value of conditional expression (10) is below the lower limit in the optical system of the present embodiment, the lenses in the second optical system closer to the image plane than the aperture stop will have strong refractive power, making it difficult to correct aberrations, such as spherical aberration, coma aberration, and curvature of field, in the second optical system.

In the optical system of the present embodiment, the effect of the present embodiment can be ensured by setting the lower limit of conditional expression (10) to 1.60. To further ensure the effect of the present embodiment, the lower limit of conditional expression (10) is preferably set to 2.00 or 2.40, more preferably to 2.80.

Preferably, the first rear lens group includes an aperture stop, and the optical system of the present embodiment satisfies the following conditional expression.

$$2.30 < f ( gr 2 L ) / f ( L ) < 8.80 \qquad ( 11 )$$

where
f(gr2L): the combined focal length of lenses in the first rear lens group closer to the image plane than the aperture stop
f(L): the focal length of the first optical system

Conditional expression (11) restricts the ratio of the combined focal length of lenses in the first rear lens group closer to the image plane than the aperture stop to the focal length of the first optical system. The optical system of the present embodiment, which satisfies conditional expression (11), can avoid the first optical system having to have a long total optical length and correct aberrations, such as spherical aberration, coma aberration, and curvature of field, appropriately.

If the value of conditional expression (11) exceeds the upper limit in the optical system of the present embodiment, the lenses in the first optical system closer to the image plane than the aperture stop will have weak refractive power to cause the total optical length to be too long, and it will be difficult to correct aberrations, such as spherical aberration, coma aberration, and curvature of field.

In the optical system of the present embodiment, the effect of the present embodiment can be ensured by setting the upper limit of conditional expression (11) to 8.80. To further ensure the effect of the present embodiment, the upper limit of conditional expression (11) is preferably set to 8.00 or 7.20, more preferably to 6.40.

If the value of conditional expression (11) is below the lower limit in the optical system of the present embodiment, the lenses in the first optical system closer to the image plane than the aperture stop will have strong refractive power, making it difficult to correct aberrations, such as spherical aberration, coma aberration, and curvature of field, in the first optical system.

In the optical system of the present embodiment, the effect of the present embodiment can be ensured by setting the lower limit of conditional expression (11) to 2.30. To further ensure the effect of the present embodiment, the lower limit of conditional expression (11) is preferably set to 3.00 or 3.70, more preferably to 4.30.

The optical system of the present embodiment preferably satisfies the following conditional expression.

$$0.23 < f ( lS ) / f ( 1 L ) < 1.50 \qquad ( 17 )$$

where
f(lS): the focal length of a lens closest to the image plane in the second rear lens group
f(lL): the focal length of a lens closest to the image plane in the first rear lens group

Conditional expression (17) restricts the ratio of the focal length of a lens closest to the image plane in the second rear lens group to the focal length of a lens closest to the image plane in the first rear lens group. The optical system of the present embodiment, which satisfies conditional expression (17), can reduce deviation of focus positions on the image plane with respect to a predetermined field angle in the first and second optical systems.

If the value of conditional expression (17) exceeds the upper limit in the optical system of the present embodiment, it will be difficult to correct distortions of the first and second optical systems so that they are similar, and deviation of focus positions on the image plane with respect to the predetermined field angle in each optical system will be increased.

In the optical system of the present embodiment, the effect of the present embodiment can be ensured by setting the upper limit of conditional expression (17) to 1.50. To further ensure the effect of the present embodiment, the upper limit of conditional expression (17) is preferably set to 1.40 or 1.30, more preferably to 1.20.

If the value of conditional expression (17) is below the lower limit in the optical system of the present embodiment, it will be difficult to correct distortions of the first and second optical systems so that they are similar, and deviation of focus positions on the image plane with respect to the predetermined field angle in each optical system will be increased.

In the optical system of the present embodiment, the effect of the present embodiment can be ensured by setting the lower limit of conditional expression (17) to 0.23. To further ensure the effect of the present embodiment, the lower limit of conditional expression (17) is preferably set to 0.36 or 0.49, more preferably to 0.62.

The optical system of the present embodiment preferably satisfies the following conditional expression.

$$0.01 < - f ( gr 1 n ) / f ( gr 1 p ) < 0.21 \qquad ( 5 )$$

where
f(gr1p): the combined focal length of a positive lens disposed closest to the object side of positive lenses in the front lens group and one or more positive lenses disposed next to the positive lens on the image plane side

Conditional expression (5) restricts the ratio of the combined focal length of a negative lens disposed closest to the object side of negative lenses in the front lens group and one or more negative lenses disposed next to the negative lens on the image plane side to the combined focal length of a positive lens disposed closest to the object side of positive lenses in the front lens group and one or more positive lenses disposed next to the positive lens on the image plane side. The optical system of the present embodiment, which satisfies conditional expression (5), can avoid the lens closest to the object side having to have a large diameter, correct aberrations, such as curvature of field and distortion, appropriately, and reduce the degree of difficulty in making a splitting plane of predetermined performance.

If the value of conditional expression (5) exceeds the upper limit in the optical system of the present embodiment, the angle of incidence on the splitting plane will be too large, making it difficult to make a splitting plane of predetermined performance.

In the optical system of the present embodiment, the effect of the present embodiment can be ensured by setting the upper limit of conditional expression (5) to 0.21. To further ensure the effect of the present embodiment, the upper limit of conditional expression (5) is preferably set to 0.18 or 0.15, more preferably to 0.12.

If the value of conditional expression (5) is below the lower limit in the optical system of the present embodiment, the front lens group will have weak refractive power to cause the diameter of the lens closest to the object side to be too large, and it will be difficult to correct aberrations, such as curvature of field and distortion.

In the optical system of the present embodiment, the effect of the present embodiment can be ensured by setting the lower limit of conditional expression (5) to 0.01. To further ensure the effect of the present embodiment, the lower limit of conditional expression (5) is preferably set to 0.02 or 0.03, more preferably to 0.04.

The optical system of the present embodiment preferably satisfies the following conditional expression.

$$1.50 < Nave ( s ) < 1.90 \qquad ( 16 )$$

where
Nave(s): an average of the refractive indices at s-line of negative lenses in the front lens group

Conditional expression (16) restricts an average of the refractive indices at s-line of negative lenses in the front lens group. The optical system of the present embodiment, which satisfies conditional expression (16), can correct aberrations, such as distortion and curvature of field, appropriately.

If the value of conditional expression (16) exceeds the upper limit in the optical system of the present embodiment, the negative lenses included in the front lens group will have too strong refractive power at s-line, making it difficult to correct aberrations, such as distortion and curvature of field.

In the optical system of the present embodiment, the effect of the present embodiment can be ensured by setting the upper limit of conditional expression (16) to 1.90. To further ensure the effect of the present embodiment, the upper limit of conditional expression (16) is preferably set to 1.84 or 1.77, more preferably to 1.70.

If the value of conditional expression (16) is below the lower limit in the optical system of the present embodiment, the negative lenses included in the front lens group will have too weak refractive power at s-line, making it difficult to correct aberrations, such as distortion and curvature of field.

In the optical system of the present embodiment, the effect of the present embodiment can be ensured by setting the lower limit of conditional expression (16) to 1.50. To further ensure the effect of the present embodiment, the lower limit of conditional expression (16) is preferably set to 1.55, 1.57, or 1.58, more preferably to 1.60.

In the optical system of the present embodiment, the front lens group preferably has negative refractive power.

The optical system of the present embodiment with such a configuration can avoid the lens closest to the object side having to have a large diameter.

In the optical system of the present embodiment, the front lens group preferably includes one or more positive lenses and one or more negative lenses.

The optical system of the present embodiment with such a configuration can correct aberrations, such as curvature of field and astigmatism, appropriately.

In the optical system of the present embodiment, the first and second optical systems preferably each include a positive lens closest to the image plane.

The optical system of the present embodiment with such a configuration can correct aberrations, such as distortion, curvature of field, astigmatism, and coma aberration, favorably.

The optical system of the present embodiment preferably satisfies the following conditional expressions.

$$80. degrees < 2 ω L \qquad ( 24 )$$

$$80. degrees < 2 ω S \qquad ( 25 )$$

where
2ωL: the total field angle of the first optical system
2ωS: the total field angle of the second optical system

Conditional expression (24) restricts the total field angle of the first optical system. The optical system of the present embodiment, which satisfies conditional expression (24), enables the first optical system to have an image showing a larger area.

If the value of conditional expression (24) is below the lower limit in the optical system of the present embodiment, the first optical system cannot have an image showing a larger area.

In the optical system of the present embodiment, the effect of the present embodiment can be ensured by setting the lower limit of conditional expression (24) to 80.0 degrees. To further ensure the effect of the present embodiment, the lower limit of conditional expression (24) is preferably set to 84.00 or 87.00 degrees, more preferably to 90.00 degrees.

Conditional expression (25) restricts the total field angle of the second optical system. The optical system of the present embodiment, which satisfies conditional expression (25), enables the second optical system to have an image showing a larger area.

If the value of conditional expression (25) is below the lower limit in the optical system of the present embodiment, the second optical system cannot have an image showing a larger area.

In the optical system of the present embodiment, the effect of the present embodiment can be ensured by setting the lower limit of conditional expression (25) to 80.0 degrees. To further ensure the effect of the present embodiment, the lower limit of conditional expression (25) is preferably set to 84.00 or 87.00 degrees, more preferably to 90.00 degrees.

Preferably, in the optical system of the present embodiment, of the transmitted light and the reflected light, one is visible light and the other is near-infrared light; of the first and second optical systems, an optical system using the visible light from the splitting plane to the image plane includes a cemented lens and an optical system using the near-infrared light from the splitting plane to the image plane consists of only single lenses.

The optical system of the present embodiment can correct chromatic aberration appropriately by including a cemented lens in the optical system using the visible light from the splitting plane to the image plane. Further, the optical system of the present embodiment can be downsized by configuring the optical system using the near-infrared light from the splitting plane to the image plane with only single lenses.

An optical system that appropriately focuses, of incident light, light transmitted through the splitting plane and light reflected by the splitting plane can be achieved by the above configuration.

An optical apparatus of the present embodiment includes an optical system configured as described above. This enables achieving an optical apparatus that appropriately focuses, of incident light, light transmitted through the splitting plane and light reflected by the splitting plane, and that can execute processing with their respective images.

A method for manufacturing an optical system of the present disclosure is a method for manufacturing an optical system including first and second optical systems. The first optical system includes, in order from an object side, a front lens group, an optical path splitter with a splitting plane that transmits a first part of incident light and that reflects at least a second part of the incident light different from the first part, and a first rear lens group on which one of the transmitted light and the reflected light is incident. The second optical system includes, in order from the object side, the front lens group, the optical path splitter, and a second rear lens group on which the other of the transmitted light and the reflected light is incident. The total optical length of the first optical system is equal to or greater than the total optical length of the second optical system. The method includes disposing the lens groups and the optical path splitter so as to satisfy the following conditional expression.

$$0.50 < T ( gr 1 ) / ( - f ( gr 1 ) ) < 4.50 \qquad ( 18 )$$

where
T(gr1): the distance on the optical axis from a lens surface closest to the object side in the front lens group to a lens surface closest to an image plane in the front lens group
f(gr1): the combined focal length of the front lens group

A method for manufacturing an optical system of the present disclosure is a method for manufacturing an optical system including first and second optical systems. The first optical system includes, in order from an object side, a front lens group, a prism with a splitting plane that transmits a first part of incident light and that reflects at least a second part of the incident light different from the first part, and a first rear lens group on which one of the transmitted light and the reflected light is incident. The second optical system includes, in order from the object side, the front lens group, the prism, and a second rear lens group on which the other of the transmitted light and the reflected light is incident. The first optical system has a greater total optical length than the second optical system. The method includes disposing the lens groups and the prism so as to satisfy the following conditional expressions.

$$1.10 < T ( gr 1 ) / f ( fL ) < 5 \text{.20} \qquad ( 20 )$$

$$1. < T ( pfL ) / f ( fL ) < 11.50 \qquad ( 21 )$$

where
T(gr1): the distance on the optical axis from a lens surface closest to the object side in the front lens group to a lens surface closest to an image plane in the front lens group
f(fL): the longer of the focal lengths of the first and second optical systems
T(pfL): the length on the optical axis of the prism in the first or second optical system with a longer focal length

A method for manufacturing an optical system of the present disclosure is a method for manufacturing an optical system including first and second optical systems. The first optical system includes, in order from an object side, a front lens group, a prism with a splitting plane that transmits a first part of incident light and that reflects at least a second part of the incident light different from the first part, and a first rear lens group on which one of the transmitted light and the reflected light is incident. The second optical system includes, in order from the object side, the front lens group, the prism, and a second rear lens group on which the other of the transmitted light and the reflected light is incident. The first optical system has a greater total optical length than the second optical system. The method includes disposing the lens groups and the prism so as to satisfy the following conditional expressions.

$$2.50 < T ( gr 1 ) / f ( fS ) < 9 \text{.50} \qquad ( 22 )$$

$$3. < T ( pfS ) / f ( fS ) < 20.00 \qquad ( 23 )$$

where
T(gr1): the distance on the optical axis from a lens surface closest to the object side in the front lens group to a lens surface closest to an image plane in the front lens group
f(fS): the shorter of the focal lengths of the first and second optical systems
T(pfS): the length on the optical axis of the prism in the first or second optical system with a shorter focal length

An optical system that appropriately focuses, of incident light, light transmitted through the splitting plane and light reflected by the splitting plane can be manufactured by such methods for manufacturing an optical system.

### NUMERICAL EXAMPLES

Examples of the present application will be described below with reference to the drawings.

### First Example

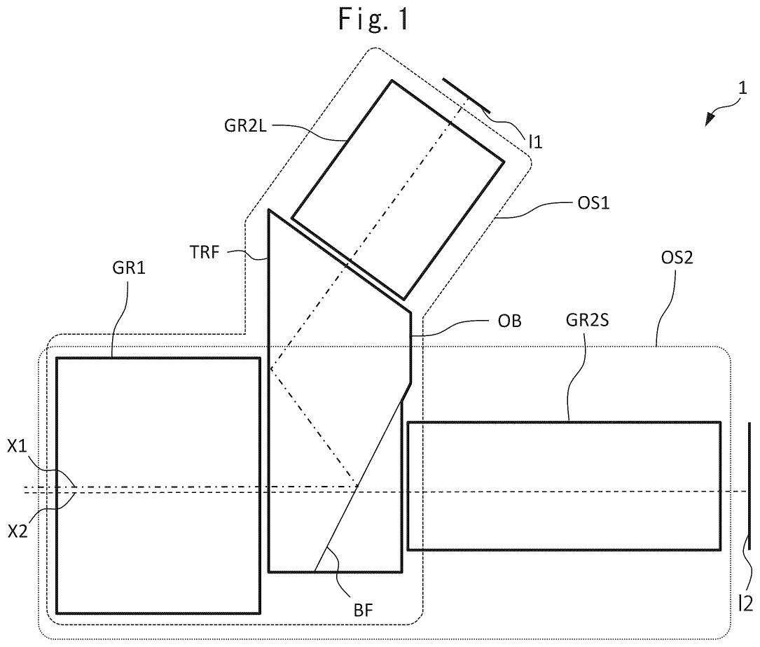

FIG. 1 schematically shows the configuration of an optical system of a first example.

The optical system 1 of the present example includes a first optical system OS1 including, in order from the object side, a front lens group GR1, an optical path splitter OB with a splitting plane BF, and a first rear lens group GR2L on which light that enters the front lens group GR1 and the optical path splitter OB and that is reflected by the splitting plane BF is incident. The optical system 1 of the present example also includes a second optical system OS2 including, in order from the object side, the front lens group GR1, the optical path splitter OB, and a second rear lens group GR2S on which light that enters the front lens group GR1 and the optical path splitter OB and that is transmitted through the splitting plane BF is incident. The first optical system OS1 has a greater total optical length than the second optical system OS2.

On the object side of the splitting plane BF, FIG. 1 shows the first optical axis X1 of the first optical system OS1 and the second optical axis X2 of the second optical system OS2 without overlap for illustrative purposes.

In the optical system 1 of the present example, the optical path splitter OB is a dichroic prism with a splitting plane BF that transmits visible light and that reflects near-infrared light. Visible light includes, for example, d-line (wavelength 587.6 nm) or g-line (wavelength 435.8 nm), and near-infrared light includes, for example, s-line (wavelength 852.1 nm).

The first optical system OS1 of the present example focuses light emitted from the front lens group GR1 and reflected by the splitting plane BF and a total reflection surface TRF of the optical path splitter OB (near-infrared light) on an image plane I1. The second optical system OS2 of the present example focuses light emitted from the front lens group GR1 and transmitted through the splitting plane BF of the optical path splitter OB (visible light) on an image plane I2.

The optical system 1 of the present example can appropriately focus, of incident light, light reflected by the splitting plane BF and light transmitted through the splitting plane BF with the first optical system OS1 and the second optical system OS2, respectively.

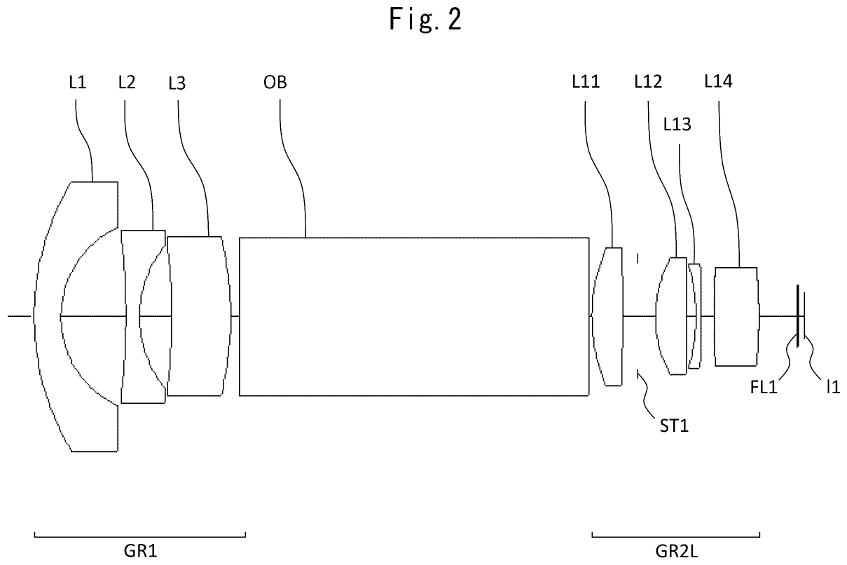

FIG. 2 is a cross-sectional view of the first optical system OS1 included in the optical system 1 of the first example.

The first optical system OS1 of the present example includes, in order from the object side, a meniscus-shaped negative lens L1 convex on the object side, a biconcave negative lens L2, a meniscus-shaped positive lens L3 concave on the object side, an optical path splitter OB, a biconvex positive lens L11, an aperture stop ST1, a meniscus-shaped positive lens L12 convex on the object side, a meniscus-shaped negative lens L13 concave on the object side, and a biconvex positive lens L14.

An imaging device constructed from CCD, CMOS, or the like is disposed on the image plane I1.

A filter FL1 is disposed between the image plane I1 and the positive lens L14 closest to the image plane I1.

In the first optical system OS1 of the present example, the negative lenses L1 and L2 and the positive lens L3 are included in the front lens group GR1. The positive lens L11, the aperture stop ST1, the positive lens L12, the negative lens L13, and the positive lens L14 are included in the first rear lens group GR2L.

Table 1-1 below shows specifications of the first optical system OS1 of the present example. In [Lens specifications] of Table 1-1, m denotes the numbers of optical surfaces counted from the object side, r the radii of curvature, d the surface-to-surface distances, n(d) the refractive indices at d-line, n(s) the refractive indices at s-line, and νd the Abbe numbers based on d-line. The radius of curvature r=∞ means a plane. In [Lens specifications], the optical surfaces with “*” are aspherical surfaces.

In [Aspherical surface data], m denotes the optical surfaces corresponding to the aspherical surface data, K the conic constants, and A4 to A10 the aspherical coefficients.

The aspherical surfaces are expressed by expression (a) below, where y denotes the height in a direction perpendicular to the optical axis, S(y) the distance along the optical axis from the tangent plane at the vertex of an aspherical surface to the aspherical surface at height y (a sag), r the radius of curvature of a reference sphere (paraxial radius of curvature), K the conic constant, and An the nth-order aspherical coefficient. In the examples, the second-order aspherical coefficient A2 is 0. “E-n” means “×10⁻ⁿ.”

$$( a )$$

$$S ( y ) = ( {y}^{2} / r ) / \{ 1 + {( 1 - K \times {y}^{2} / {r}^{2} )}^{1 / 2} \} + A 4 \times {y}^{4} + A 6 \times {y}^{6} + A 8 \times {y}^{3} + A 10 \times {y}^{10}$$

In [General specifications] of Table 1-1, Fno denotes the f-number of the optical system, f the focal length of the whole optical system, TL the total optical length, Y the image height, and 2ω the total field angle (degrees). These values listed in [General specifications] are those at d-line.

The unit of the focal length f, the radii of curvature r, and the other lengths listed in Table 1-1 is “mm.” However, the values are not limited thereto because the optical performance of a proportionally enlarged or reduced optical system is the same as that of the original optical system.

The above reference symbols in Table 1-1 will also be used similarly in the table of the second optical system OS2 of the present example and the tables of the other examples described below.

TABLE 1-1
[Lens specifications]

| m | r | d | n(d) | νd | ns | |
|---|---|---|---|---|---|---|
| 1) | 23.24716 | | 2.500 | 1.618 | 63.34 | 1.610 |
| 2) | 8.85754 | | 6.000 | | | |
| 3) | −62.73425 | | 1.300 | 1.618 | 63.34 | 1.610 |
| 4) | 10.07820 | | 2.940 | | | |
| 5) | −62.37902 | | 5.500 | 1.755 | 27.57 | 1.735 |
| 6) | −30.02650 | | 0.800 | | | |
| 7) | ∞ | 32.500 | 1.517 | 63.88 | 1.510 | (optical |
| | | | | | | path |
| | | | | | | splitter |
| | | | | | | OB) |
| 8) | ∞ | 0.230 | | | | |
| 9) | 15.44687 | | 2.850 | 1.835 | 42.73 | 1.819 |
| 10) | −300.00000 | | 1.400 | | | |
| 11> | ∞ | 1.650 | | | | (aperture |
| | | | | | | stop ST1) |
| 12) | 10.79653 | | 2.850 | 1.835 | 42.73 | 1.819 |
| 13) | 350.00000 | | 0.920 | | | |
| 14) | −15.64213 | | 0.500 | 1.835 | 42.73 | 1.819 |
| 15) | −83.64620 | | 1.190 | | | |
| *16) | 300.00000 | | 4.150 | 1.835 | 42.73 | 1.819 |
| *17) | −25.21347 | | 3.490 | | | |
| 18) | ∞ | 0.210 | 1.517 | 63.88 | 1.510 | (filter |
| | | | | | | FL1) |
| 19) | ∞ | 0.343 | | | | |

[Aspherical surface data]

| m | K | A4 | A6 | A8 | A10 |
|---|---|---|---|---|---|
| 16) | 9.2225 | 7.80E−05 | 2.38E−06 | 1.06E−06 | −3.67E−08 |
| 17) | −2.9888 | 4.80E−04 | −1.15E−05 | 3.76E−06 | −1.49E−07 |

[General specifications]

| | |
|---|---|
| Fno | 1.18 |
| f | 2.81 |
| TL | 71.25 |
| Y | 2.29 |
| 2ω | 92.00 |

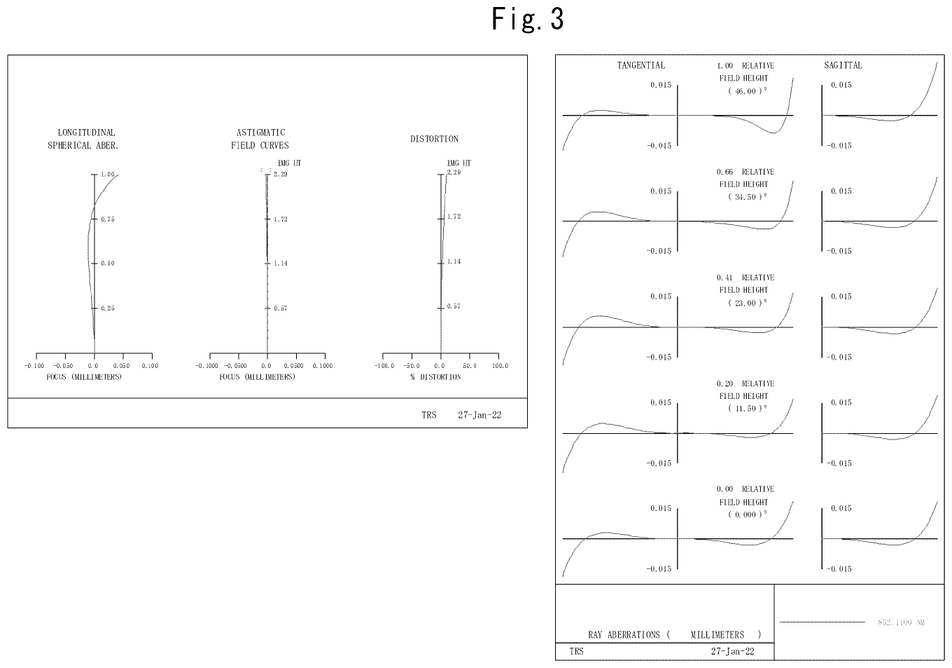

FIG. 3 shows aberrations of the first optical system OS1 included in the optical system 1 of the first example.

Of the graphs of aberrations, the graph of spherical aberration (LONGITUDINAL SPHERICAL ABER.) shows the ratio to the maximum aperture, the graphs of astigmatism and distortion (ASTIGMATIC FIELD CURVES and DISTORTION) show the values at the semi-field angle, and the graphs of coma aberration show the ratio to the maximum image height. The graphs of aberrations show the values at s-line. In the graph of astigmatism, S and T indicate a sagittal plane and a meridional plane, respectively. The reference symbols in the graphs of aberrations of the present example will also be used in those of the other examples described below.

The graphs of aberrations suggest that the first optical system OS1 of the present example corrects aberrations appropriately and has high optical performance at s-line.

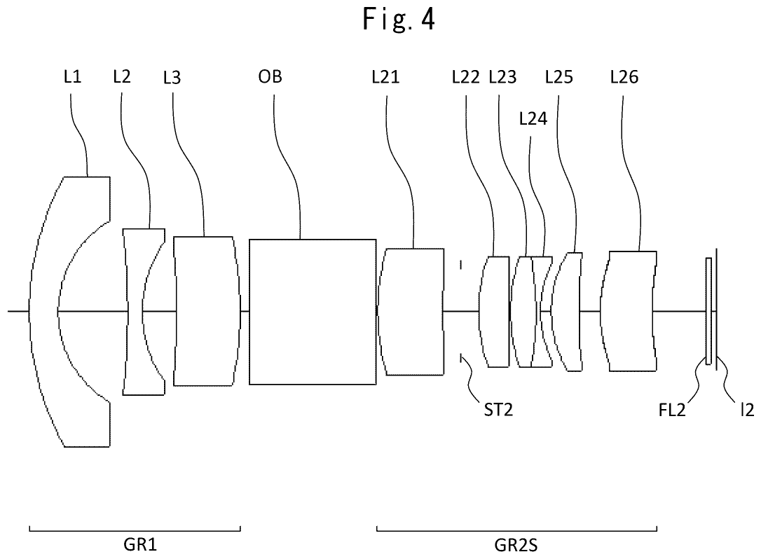

FIG. 4 is a cross-sectional view of the second optical system OS2 included in the optical system 1 of the first example.

The second optical system OS2 of the present example includes, in order from the object side, the meniscus-shaped negative lens L1 convex on the object side, the biconcave negative lens L2, the meniscus-shaped positive lens L3 concave on the object side, the optical path splitter OB, a meniscus-shaped positive lens L21 convex on the object side, an aperture stop ST2, a meniscus-shaped positive lens L22 convex on the object side, a negative cemented lens composed of a biconvex positive lens L23 and a biconcave negative lens L24, a meniscus-shaped positive lens L25 convex on the object side, and a meniscus-shaped positive lens L26 convex on the object side.

An imaging device constructed from CCD, CMOS, or the like is disposed on the image plane I2.

A filter FL2 is disposed between the image plane I2 and the positive lens L26 closest to the image plane I2.

In the second optical system OS2 of the present example, the negative lenses L1 and L2 and the positive lens L3 are included in the front lens group GR1. The positive lens L21, the aperture stop ST2, the positive lens L22, the negative cemented lens composed of the positive lens L23 and the negative lens L24, and the positive lenses L25 and L26 are included in the second rear lens group GR2S.

Table 1-2 below shows specifications of the second optical system OS2 of the present example.

TABLE 1-2
[Lens specifications]

| m | r | d | n(d) | νd | |
|---|---|---|---|---|---|
| 1) | 23.24716 | | 2.500 | 1.618 | 63.34 |
| 2) | 8.85754 | | 6.000 | | |
| 3) | −62.73425 | | 1.300 | 1.618 | 63.34 |
| 4) | 10.07820 | | 2.940 | | |
| 5) | −62.37902 | | 5.500 | 1.755 | 27.57 |
| 6) | −30.02650 | | 0.800 | | |
| 7) | ∞ | 11.000 | 1.517 | 63.88 | (optical |
| | | | | | path splitter |
| 8) | ∞ | 0.150 | | | |
| 9) | 18.88785 | | 5.650 | 1.700 | 48.10 |
| 10) | 300.00000 | | 1.540 | | |
| 11> | ∞ | 1.550 | | | (aperture |
| | | | | | stop ST2) |
| 12) | 14.36704 | | 2.600 | 1.697 | 55.52 |
| 13) | 313.89814 | | 0.150 | | |
| 14) | 15.11805 | | 2.200 | 1.519 | 69.89 |
| 15) | −25.38622 | | 0.400 | 1.755 | 27.57 |
| 16) | 9.06631 | | 0.930 | | |
| 17) | 9.42227 | | 2.400 | 1.623 | 58.12 |
| 18) | 42.81721 | | 1.830 | | |
| *19) | 11.33584 | | 4.500 | 1.623 | 58.12 |
| *20) | 23.57318 | | 4.660 | | |
| 21) | ∞ | 0.500 | 1.517 | 63.88 | (filter FL2) |
| 22) | ∞ | 0.359 | | | |

[Aspherical surface data]

| m | K | A4 | A6 | A8 | A10 |
|---|---|---|---|---|---|
| 19) | −1.1497 | −7.48E−05 | −1.27E−06 | −8.15E−08 | 7.15E−10 |
| 20) | −4.4220 | 8.96E−05 | −2.30E−06 | −3.03E−08 | 3.23E−10 |

[General specifications]

| | |
|---|---|
| Fno | 2.00 |
| f | 4.99 |
| TL | 59.29 |
| Y | 4.01 |
| 2ω | 92.00 |

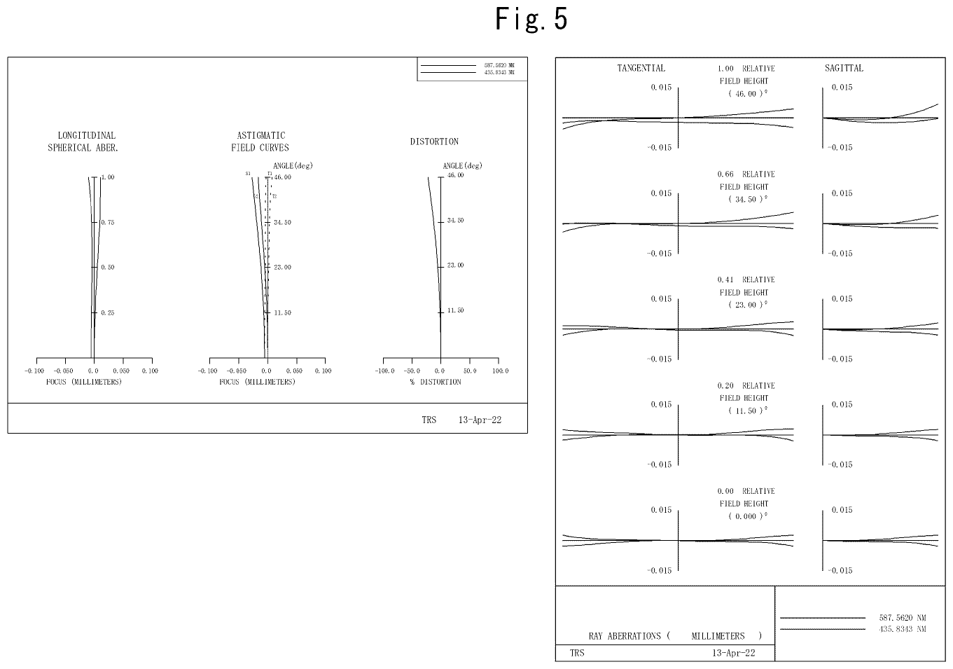

FIG. 5 shows aberrations of the second optical system OS2 included in the optical system 1 of the first example. The graphs of aberrations show the values at d-line and g-line.

The graphs of aberrations suggest that the second optical system OS2 of the present example corrects aberrations appropriately and has high optical performance at d-line and g-line.

### Second Example

The optical system 1 of the present example has roughly the same configuration as the optical system 1 of the first example described with reference to FIG. 1.

In the optical system 1 of the present example, the optical path splitter OB is a dichroic prism with a splitting plane BF that transmits near-infrared light and that reflects visible light.

The first optical system OS1 of the present example focuses light emitted from the front lens group GR1 and reflected by the splitting plane BF and a total reflection surface TRF of the optical path splitter OB (visible light) on an image plane I1. The second optical system OS2 of the present example focuses light emitted from the front lens group GR1 and transmitted through the splitting plane BF of the optical path splitter OB (near-infrared light) on an image plane I2.

The optical system 1 of the present example can appropriately focus, of incident light, light reflected by the splitting plane BF and light transmitted through the splitting plane BF with the first optical system OS1 and the second optical system OS2, respectively.

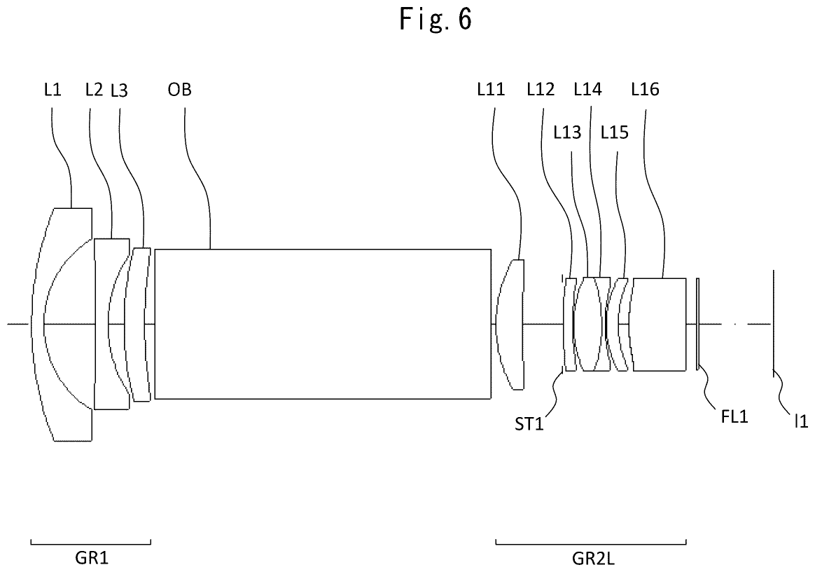

FIG. 6 is a cross-sectional view of the first optical system OS1 included in the optical system 1 of the second example.

The first optical system OS1 of the present example includes, in order from the object side, a meniscus-shaped negative lens L1 convex on the object side, a biconcave negative lens L2, a meniscus-shaped positive lens L3 convex on the object side, an optical path splitter OB, a meniscus-shaped positive lens L11 convex on the object side, an aperture stop ST1, a meniscus-shaped negative lens L12 convex on the object side, a negative cemented lens composed of a biconvex positive lens L13 and a biconcave negative lens L14, a meniscus-shaped positive lens L15 convex on the object side, and a meniscus-shaped positive lens L16 convex on the object side.

An imaging device constructed from CCD, CMOS, or the like is disposed on the image plane I1.

A filter FL1 is disposed between the image plane I1 and the positive lens L16 closest to the image plane I1.

In the first optical system OS1 of the present example, the negative lenses L1 and L2 and the positive lens L3 are included in the front lens group GR1. The positive lens L11, the aperture stop ST1, the negative lens L12, the negative cemented lens composed of the positive lens L13 and the negative lens L14, and the positive lenses L15 and L16 are included in the first rear lens group GR2L.

Table 2-1 below shows specifications of the first optical system OS1 of the present example.

TABLE 2-1
[Lens specifications]

| m | r | d | n(d) | νd | |
|---|---|---|---|---|---|
| 1) | 29.68900 | | 1.200 | 1.640 | 60.19 |
| 2) | 9.70090 | | 5.000 | | |
| 3) | −195.75730 | | 1.200 | 1.618 | 63.34 |
| 4) | 11.92140 | | 1.550 | | |
| 5) | 28.18830 | | 2.000 | 1.755 | 27.57 |
| 6) | 43.38750 | | 1.000 | | |
| 7) | ∞ | 32.500 | 1.517 | 63.88 | (optical path |
| | | | | | splitter OB) |
| 8) | ∞ | 0.500 | | | |
| 9) | 12.82210 | | 2.620 | 1.700 | 48.10 |
| 10) | 302.64820 | | 3.760 | | |
| 11> | ∞ | 0.100 | | | (aperture |
| | | | | | stop ST1) |
| 12) | 30.12150 | | 0.955 | 1.651 | 56.24 |
| 13) | 26.67870 | | 0.100 | | |
| 14) | 10.81720 | | 2.710 | 1.519 | 69.89 |
| 15) | −14.47040 | | 0.350 | 1.755 | 27.57 |
| 16) | 16.24750 | | 0.100 | | |
| 17) | 9.11660 | | 1.150 | 1.620 | 60.24 |
| 18) | 10.15080 | | 1.039 | | |
| *19) | 14.74820 | | 5.500 | 1.620 | 60.24 |
| *20) | 270.84350 | | 1.000 | | |
| 21) | ∞ | 0.300 | 1.517 | 63.88 | (filter FL1) |
| 22) | ∞ | 7.217 | | | |

[Aspherical surface data]

| m | K | A4 | A6 | A8 | A10 |
|---|---|---|---|---|---|
| 19) | −3.2435 | −2.20E−04 | −3.59E−06 | 3.52E−09 | 2.17E−10 |
| 20) | 11.0000 | −4.40E−05 | −1.45E−06 | 4.57E−08 | −2.20E−10 |

[General specifications]

| | |
|---|---|
| Fno | 2.10 |
| f | 5.03 |
| TL | 71.75 |
| Y | 4.02 |
| 2ω | 92.00 |

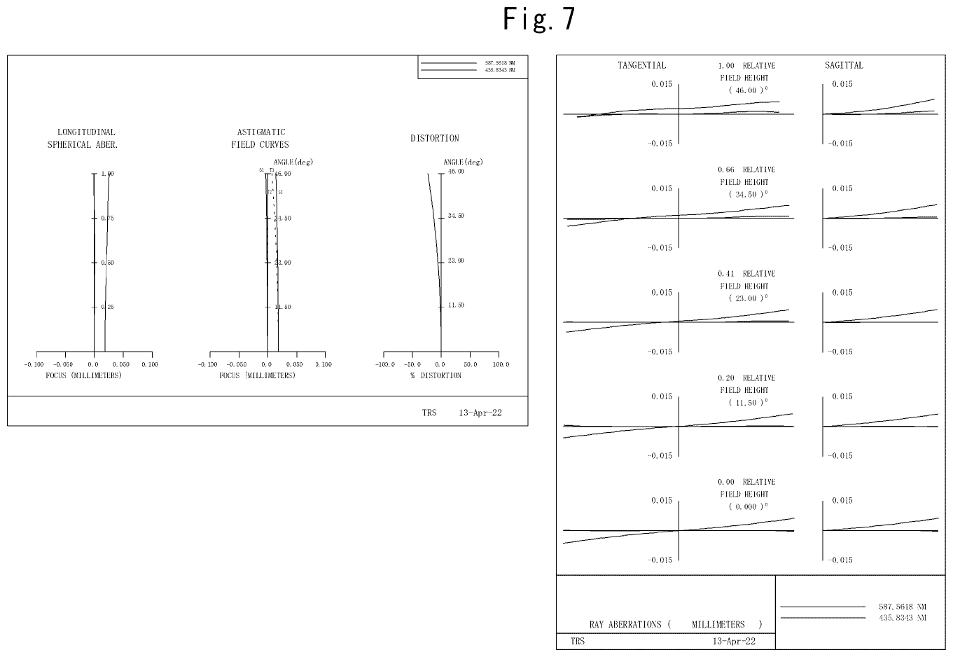

FIG. 7 shows aberrations of the first optical system OS1 included in the optical system 1 of the second example. The graphs of aberrations show the values at d-line and g-line.

The graphs of aberrations suggest that the first optical system OS1 of the present example corrects aberrations appropriately and has high optical performance at d-line and g-line.

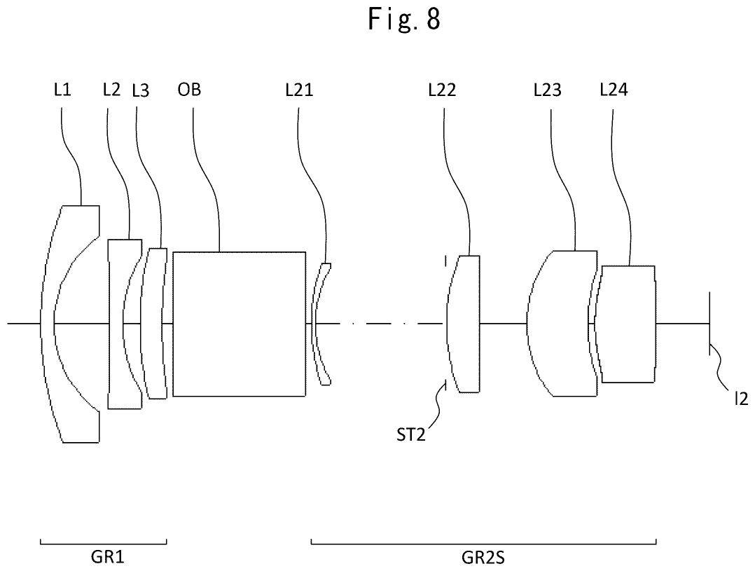

FIG. 8 is a cross-sectional view of the second optical system OS2 included in the optical system 1 of the second example.

The second optical system OS2 of the present example includes, in order from the object side, the meniscus-shaped negative lens L1 convex on the object side, the biconcave negative lens L2, the meniscus-shaped positive lens L3 convex on the object side, the optical path splitter OB, a meniscus-shaped negative lens L21 convex on the object side, an aperture stop ST2, a biconvex positive lens L22, a meniscus-shaped positive lens L23 convex on the object side, and a biconvex positive lens L24.

An imaging device constructed from CCD, CMOS, or the like is disposed on the image plane I2.

In the second optical system OS2 of the present example, the negative lenses L1 and L2 and the positive lens L3 are included in the front lens group GR1. The negative lens L21, the aperture stop ST2, and the positive lenses L22, L23, and L24 are included in the second rear lens group GR2S.

Table 2-2 below shows specifications of the second optical system OS2 of the present example.

TABLE 2-2
[Lens specifications]

| m | r | d | n(d) | νd | ns | |
|---|---|---|---|---|---|---|
| 1) | 29.68897 | | 1.200 | 1.640 | 60.20 | 1.631 |
| 2) | 9.70092 | | 5.000 | | | |
| 3) | −195.75734 | | 1.200 | 1.618 | 63.34 | 1.610 |
| 4) | 11.92145 | | 1.550 | | | |
| 5) | 28.18828 | | 2.000 | 1.755 | 27.57 | 1.735 |
| 6) | 43.38751 | | 1.000 | | | |
| 7) | ∞ | 12.000 | 1.517 | 63.88 | 1.510 | (optical path |
| | | | | | | splitter OB) |
| 8) | ∞ | 0.500 | | | | |
| 9) | 16.64118 | | 0.350 | 1.532 | 48.78 | 1.523 |
| 10) | 9.69527 | | 11.748 | | | |
| 11> | ∞ | 0.100 | | | | (aperture |
| | | | | | | stop ST2) |
| 12) | 16.58651 | | 3.000 | 1.755 | 27.57 | 1.735 |
| 13) | −531.70077 | | 4.273 | | | |
| 14) | 10.44070 | | 5.497 | 1.755 | 27.57 | 1.735 |
| 15) | 14.92879 | | 0.647 | | | |
| *16) | 13.31421 | | 5.500 | 1.774 | 47.18 | 1.760 |
| 17) | −128.00260 | | 4.854 | | | |

[Aspherical surface data]

| m | K | A4 | A6 | A8 | A10 |
|---|---|---|---|---|---|
| 16) | −4.0120 | −1.07E−04 | −5.73E−06 | 1.74E−08 | 6.04E−10 |

[General specifications]

| | |
|---|---|
| Fno | 1.20 |
| f | 2.77 |
| TL | 60.42 |
| Y | 2.20 |
| 2ω | 92.00 |

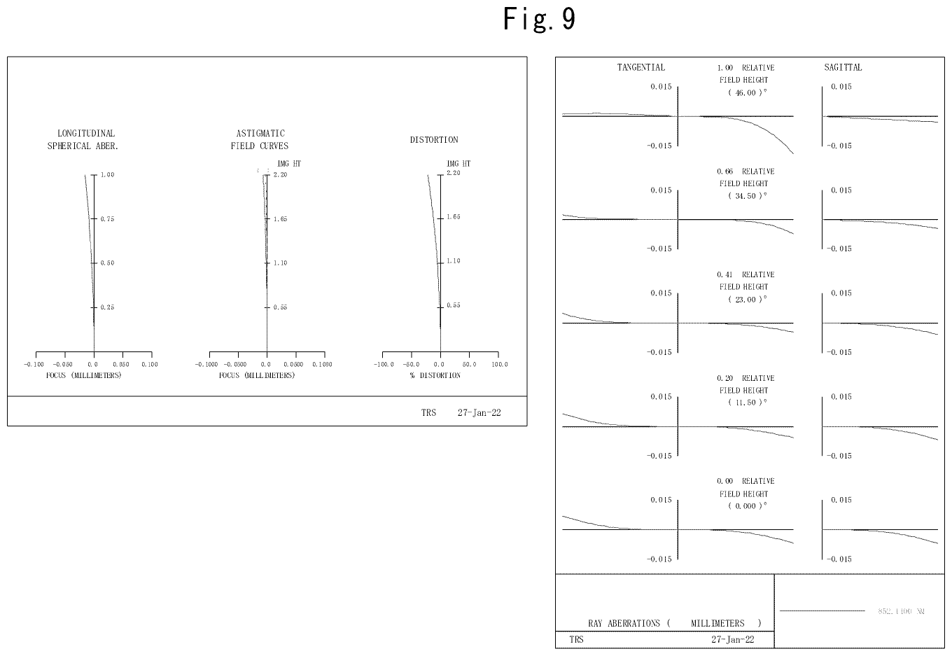

FIG. 9 shows aberrations of the second optical system OS2 included in the optical system 1 of the second example. The graphs of aberrations show the values at s-line.

The graphs of aberrations suggest that the second optical system OS2 of the present example corrects aberrations appropriately and has high optical performance at s-line.

### Third Example

The optical system 1 of the present example has roughly the same configuration as the optical system 1 of the first example described with reference to FIG. 1.

In the optical system 1 of the present example, the optical path splitter OB is a dichroic prism with a splitting plane BF that transmits visible light and that reflects near-infrared light.

The first optical system OS1 of the present example focuses light emitted from the front lens group GR1 and reflected by the splitting plane BF and a total reflection surface TRF of the optical path splitter OB (near-infrared light) on an image plane I1. The second optical system OS2 of the present example focuses light emitted from the front lens group GR1 and transmitted through the splitting plane BF of the optical path splitter OB (visible light) on an image plane I2.

The optical system 1 of the present example can appropriately focus, of incident light, light reflected by the splitting plane BF and light transmitted through the splitting plane BF with the first optical system OS1 and the second optical system OS2, respectively.

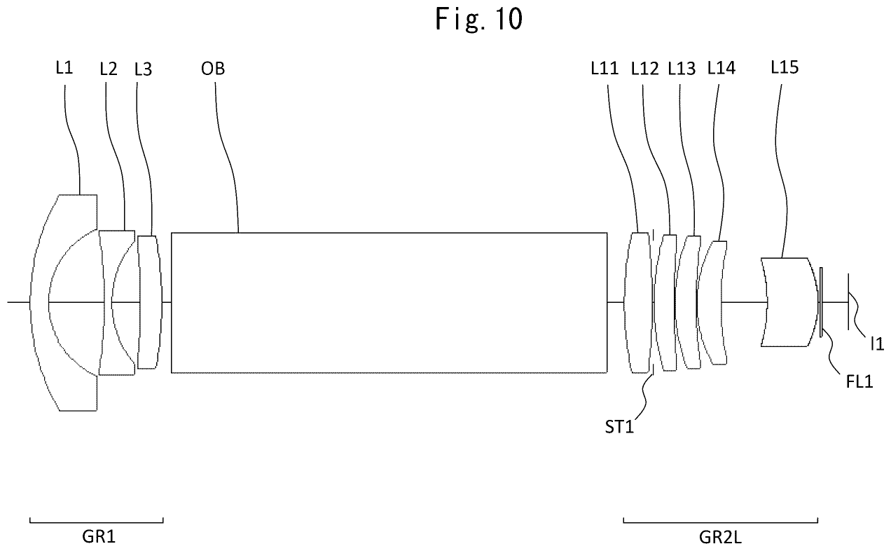

FIG. 10 is a cross-sectional view of the first optical system OS1 included in the optical system 1 of the third example.

The first optical system OS1 of the present example includes, in order from the object side, a meniscus-shaped negative lens L1 convex on the object side, a biconcave negative lens L2, a meniscus-shaped positive lens L3 concave on the object side, an optical path splitter OB, a biconvex positive lens L11, an aperture stop ST1, a meniscus-shaped positive lens L12 convex on the object side, a meniscus-shaped positive lens L13 convex on the object side, a meniscus-shaped positive lens L14 convex on the object side, and a meniscus-shaped positive lens L15 concave on the object side.

An imaging device constructed from CCD, CMOS, or the like is disposed on the image plane I1.

A filter FL1 is disposed between the image plane I1 and the positive lens L15 closest to the image plane I1.

In the first optical system OS1 of the present example, the negative lenses L1 and L2 and the positive lens L3 are included in the front lens group GR1. The positive lens L11, the aperture stop ST1, and the positive lenses L12, L13, L14, and L15 are included in the first rear lens group GR2L.

Table 3-1 below shows specifications of the first optical system OS1 of the present example.

TABLE 3-1
[Lens specifications]

| m | r | d | n(d) | νd | ns | |
|---|---|---|---|---|---|---|
| 1) | 22.65975 | | 2.000 | 1.603 | 60.69 | 1.595 |
| 2) | 8.58484 | | 6.013 | | | |
| 3) | −46.67377 | | 0.800 | 1.519 | 69.89 | 1.512 |
| 4) | 10.08192 | | 3.049 | | | |
| 5) | −69.22039 | | 2.313 | 1.755 | 27.57 | 1.735 |
| 6) | −40.41329 | | 0.988 | | | |
| 7) | ∞ | 47.000 | 1.517 | 63.88 | 1.510 | (optical |
| | | | | | | path |
| | | | | | | splitter |
| | | | | | | OB) |
| 8) | ∞ | 1.805 | | | | |
| 9) | 33.91430 | | 3.017 | 1.720 | 50.27 | 1.708 |
| 10) | −66.06093 | | 0.100 | | | |
| 11> | ∞ | 0.100 | | | | (aper- |
| | | | | | | ture |
| | | | | | | stop |
| | | | | | | ST1) |
| 12) | 26.49772 | | 2.147 | 1.623 | 58.12 | 1.614 |
| 13) | 74.01188 | | 0.100 | | | |
| 14) | 19.60218 | | 2.271 | 1.593 | 67.90 | 1.586 |
| 15) | 46.09410 | | 0.100 | | | |
| 16) | 13.36196 | | 2.584 | 1.487 | 70.31 | 1.481 |
| 17) | 29.13116 | | 4.967 | | | |
| *18) | −19.16636 | | 5.496 | 1.487 | 70.31 | 1.481 |
| *19) | −9.49217 | | 0.182 | | | |
| 20) | ∞ | 0.300 | 1.517 | 63.88 | 1.510 | (filter |
| | | | | | | FL1) |
| 21) | ∞ | 3.000 | | | | |

[Aspherical surface data]

| m | K | A4 | A6 | A8 | A10 |
|---|---|---|---|---|---|
| 18) | −2.2395 | −3.29E−04 | 3.25E−06 | 1.17E−07 | −4.08E−09 |
| 19) | 0.3196 | −1.85E−05 | 1.28E−05 | −1.34E−07 | −8.44E−09 |

[General specifications]

| | |
|---|---|
| Fno | 1.20 |
| f | 2.93 |
| TL | 88.00 |
| Y | 2.29 |
| 2ω | 92.00 |

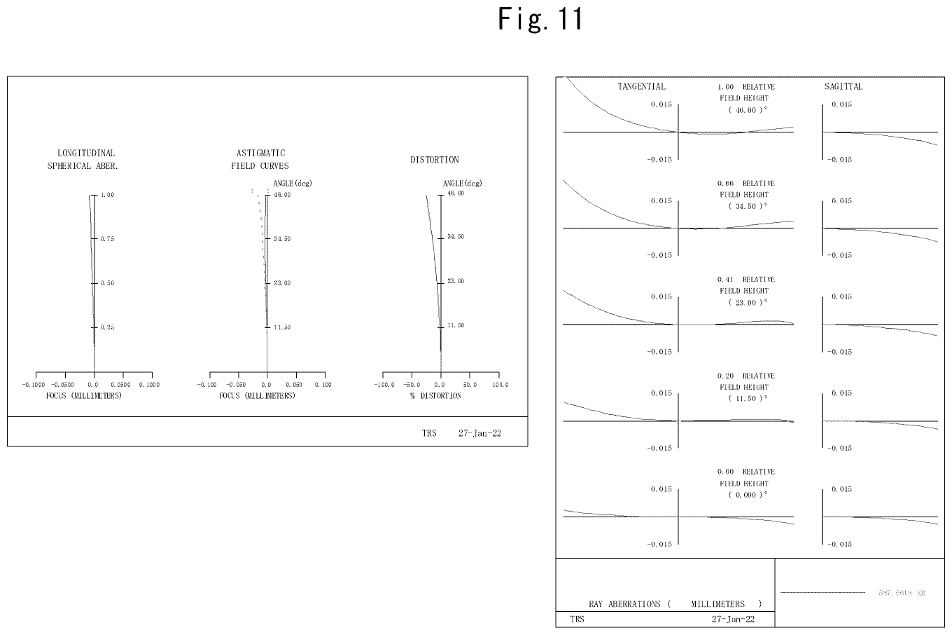

FIG. 11 shows aberrations of the first optical system OS1 included in the optical system 1 of the third example. The graphs of aberrations show the values at s-line.

The graphs of aberrations suggest that the first optical system OS1 of the present example corrects aberrations appropriately and has high optical performance at s-line.

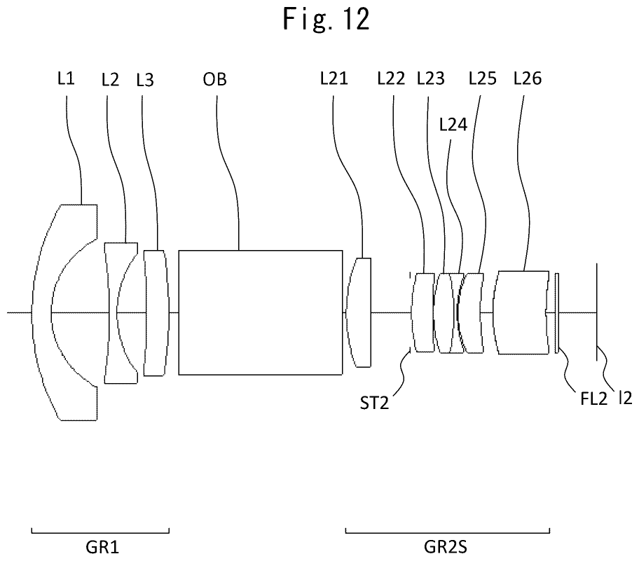

FIG. 12 is a cross-sectional view of the second optical system OS2 included in the optical system 1 of the third example.

The second optical system OS2 of the present example includes, in order from the object side, the meniscus-shaped negative lens L1 convex on the object side, the biconcave negative lens L2, the meniscus-shaped positive lens L3 concave on the object side, the optical path splitter OB, a meniscus-shaped positive lens L21 convex on the object side, an aperture stop ST2, a meniscus-shaped positive lens L22 convex on the object side, a negative cemented lens composed of a biconvex positive lens L23 and a biconcave negative lens L24, a meniscus-shaped positive lens L25 convex on the object side, and a meniscus-shaped positive lens L26 convex on the object side.

An imaging device constructed from CCD, CMOS, or the like is disposed on the image plane I2.

A filter FL2 is disposed between the image plane I2 and the positive lens L26 closest to the image plane I2.

In the second optical system OS2 of the present example, the negative lenses L1 and L2 and the positive lens L3 are included in the front lens group GR1. The positive lens L21, the aperture stop ST2, the positive lens L22, the negative cemented lens composed of the positive lens L23 and the negative lens L24, and the positive lenses L25 and L26 are included in the second rear lens group GR2S.

Table 3-2 below shows specifications of the second optical system OS2 of the present example.

TABLE 3-2
[Lens specifications]

| m | r | d | n(d) | νd | |
|---|---|---|---|---|---|
| 1) | 22.65975 | | 2.000 | 1.603 | 60.69 |
| 2) | 8.58484 | | 6.013 | | |
| 3) | −46.67377 | | 0.800 | 1.519 | 69.89 |
| 4) | 10.08192 | | 3.049 | | |
| 5) | −69.22039 | | 2.313 | 1.755 | 27.57 |
| 6) | −40.41329 | | 0.988 | | |
| 7) | ∞ | 17.000 | 1.517 | 63.88 | (optical |
| | | | | | path |
| | | | | | splitter |
| | | | | | OB) |
| 8) | ∞ | 0.384 | | | |
| 9) | | | | | |
| 10) | 15.15381 | | 2.574 | 1.720 | 50.27 |
| 11> | 516.88017 | | 4.098 | | |
| | ∞ | 0.100 | | | |
| 12) | 15.83971 | | 2.165 | 1.651 | 56.24 |
| 13) | 42.97328 | | 0.100 | | |
| 14) | 12.34848 | | 2.119 | 1.519 | 69.89 |
| 15) | −21.04824 | | 0.350 | 1.755 | 27.57 |
| 16) | 10.90829 | | 0.100 | | |
| 17) | 9.48441 | | 2.289 | 1.620 | 60.24 |
| 18) | 23.82029 | | 1.297 | | |
| *19) | 12.79368 | | 5.503 | 1.620 | 60.24 |
| *20) | 25.72131 | | 1.000 | | |
| 21) | ∞ | 0.300 | 1.517 | 63.88 | (filter |
| | | | | | FL2) |
| 22) | ∞ | 3.960 | | | |

[Aspherical surface data]

| m | K | A4 | A6 | A8 | A10 |
|---|---|---|---|---|---|
| 19) | −2.0024 | −1.76E−04 | −2.50E−06 | −1.86E−08 | 3.06E−10 |
| 20) | 11.0000 | 8.87E−05 | −1.45E−06 | 1.92E−08 | 4.13E−09 |

[General specifications]

| | |
|---|---|
| Fno | 2.00 |
| f | 4.93 |
| TL | 58.40 |
| Y | 4.01 |
| 2ω | 92.00 |

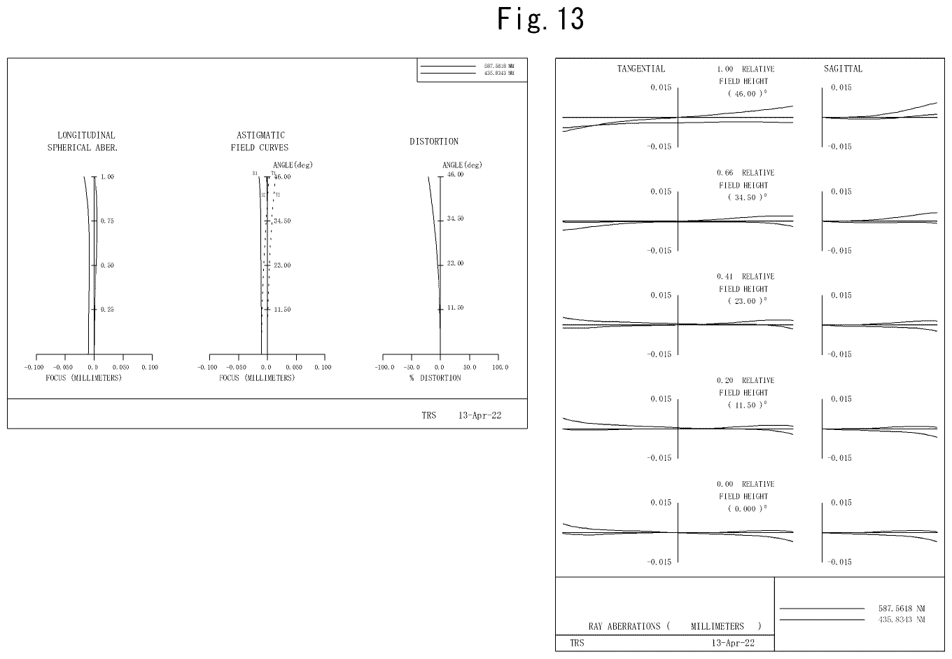

FIG. 13 shows aberrations of the second optical system OS2 included in the optical system 1 of the third example. The graphs of aberrations show the values at d-line and g-line.

The graphs of aberrations suggest that the second optical system OS2 of the present example corrects aberrations appropriately and has high optical performance at d-line and g-line.

### Fourth Example

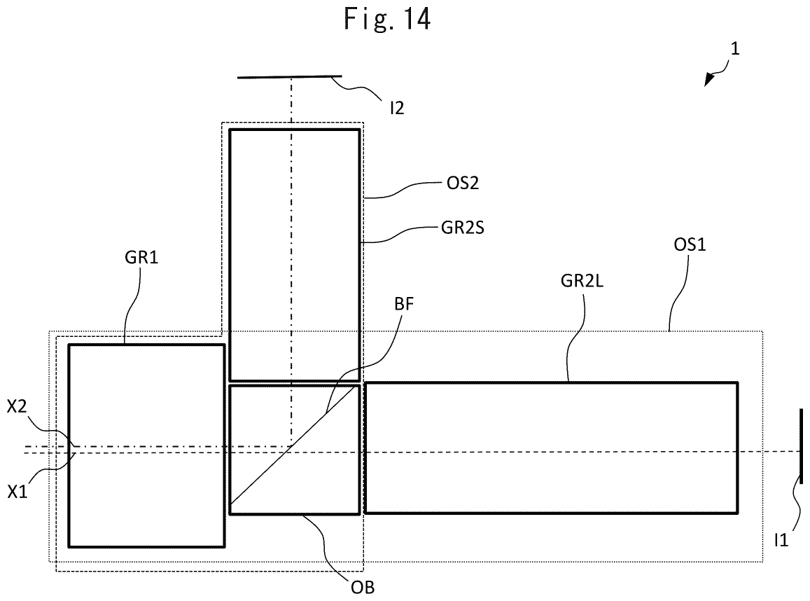

FIG. 14 schematically shows the configuration of an optical system of a fourth example.

The optical system 1 of the present example includes a first optical system OS1 including, in order from the object side, a front lens group GR1, an optical path splitter OB with a splitting plane BF, and a first rear lens group GR2L on which light that enters the front lens group GR1 and the optical path splitter OB and that is transmitted through the splitting plane BF is incident. The optical system 1 of the present example also includes a second optical system OS2 including, in order from the object side, the front lens group GR1, the optical path splitter OB, and a second rear lens group GR2S on which light that enters the front lens group GR1 and the optical path splitter OB and that is reflected by the splitting plane BF is incident. The first optical system OS1 has a greater total optical length than the second optical system OS2.

On the object side of the splitting plane BF, FIG. 14 shows the first optical axis X1 of the first optical system OS1 and the second optical axis X2 of the second optical system OS2 without overlap for illustrative purposes.

In the optical system 1 of the present example, the optical path splitter OB is a dichroic prism with a splitting plane BF that transmits near-infrared light and that reflects visible light.

The first optical system OS1 of the present example focuses light emitted from the front lens group GR1 and transmitted through the splitting plane BF of the optical path splitter OB (near-infrared light) on an image plane I1. The second optical system OS2 of the present example focuses light emitted from the front lens group GR1 and reflected by the splitting plane BF of the optical path splitter OB (visible light) on an image plane I2.

The optical system 1 of the present example can appropriately focus, of incident light, light transmitted through the splitting plane BF and light reflected by the splitting plane BF with the first optical system OS1 and the second optical system OS2, respectively.

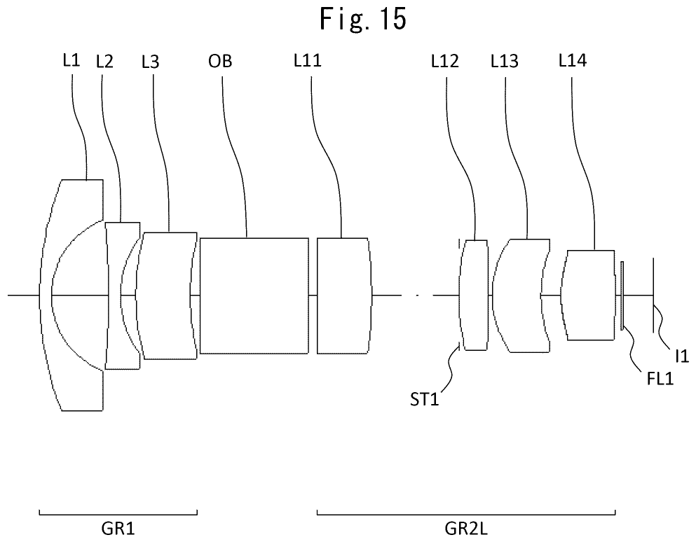

FIG. 15 is a cross-sectional view of the first optical system OS1 included in the optical system 1 of the fourth example.

The first optical system OS1 of the present example includes, in order from the object side, a meniscus-shaped negative lens L1 convex on the object side, a biconcave negative lens L2, a meniscus-shaped positive lens L3 convex on the object side, an optical path splitter OB, a biconvex positive lens L11, an aperture stop ST1, a biconvex positive lens L12, a meniscus-shaped positive lens L13 convex on the object side, and a biconvex positive lens L14.

An imaging device constructed from CCD, CMOS, or the like is disposed on the image plane I1.

A filter FL1 is disposed between the image plane I1 and the positive lens L14 closest to the image plane I1.

In the first optical system OS1 of the present example, the negative lenses L1 and L2 and the positive lens L3 are included in the front lens group GR1. The positive lens L11, the aperture stop ST1, and the positive lenses L12, L13, and L14 are included in the first rear lens group GR2L.

Table 4-1 below shows specifications of the first optical system OS1 of the present example.

TABLE 4-1
[Lens specifications]

| m | r | d | n(d) | νd | ns | |
|---|---|---|---|---|---|---|
| 1) | 31.56470 | | 1.190 | 1.640 | 60.20 | 1.631 |
| 2) | 8.14860 | | 5.800 | | | |
| 3) | −75.53150 | | 1.190 | 1.618 | 63.34 | 1.610 |
| 4) | 9.75210 | 1.550 | | | | |
| 5) | 23.57220 | | 5.500 | 1.755 | 27.57 | 1.735 |
| 6) | 23.35310 | 1.000 | | | | |
| 7) | ∞ | 11.000 | 1.517 | 63.88 | 1.510 | (optical |
| | | | | | | path |
| | | | | | | splitter |
| | | | | | | OB) |
| 8) | ∞ | 0.870 | | | | |
| 9) | 505.32550 | | 5.500 | 1.487 | 70.31 | 1.481 |
| 10) | −42.66070 | | 8.800 | | | |
| 11> | ∞ | 0.000 | | | | (aperture |
| | | | | | | stop ST1) |
| 12) | 21.15710 | | 3.000 | 1.755 | 27.57 | 1.735 |
| 13) | −193.50380 | | 0.400 | | | |
| 14) | 9.59100 | | 4.950 | 1.755 | 27.57 | 1.735 |
| 15) | 13.32120 | | 2.000 | | | |
| *16) | 10.35130 | | 5.500 | 1.541 | 46.97 | 1.531 |
| *17) | −58.16010 | | 0.550 | | | |
| 18) | ∞ | 0.300 | 1.517 | 63.88 | 1.510 | (filter |
| | | | | | | FL1) |
| 19) | ∞ | 2.715 | | | | |

[Aspherical surface data]

| m | K | A4 | A6 | A8 | A10 |
|---|---|---|---|---|---|
| 16) | −7.0241 | 3.20E−04 | −2.94E−05 | 5.31E−07 | −2.57E−09 |
| 17) | −9.0000 | −1.88E−04 | −1.08E−06 | 8.31E−07 | −5.15E−09 |

[General specifications]

| | |
|---|---|
| Fno | 1.24 |
| f | 2.81 |
| TL | 61.71 |
| Y | 2.29 |
| 2ω | 92.00 |

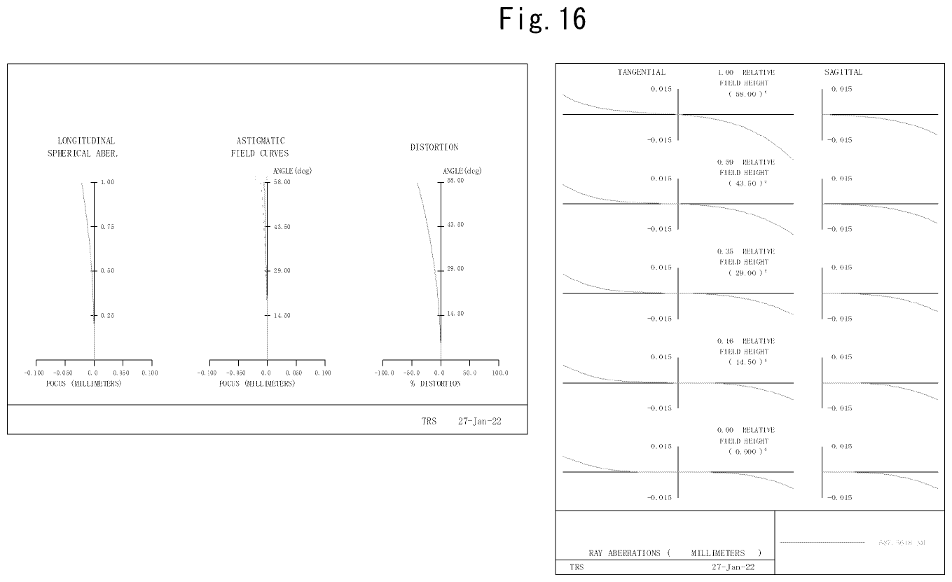

FIG. 16 shows aberrations of the first optical system OS1 included in the optical system 1 of the fourth example. The graphs of aberrations show the values at s-line.

The graphs of aberrations suggest that the first optical system OS1 of the present example corrects aberrations appropriately and has high optical performance at s-line.

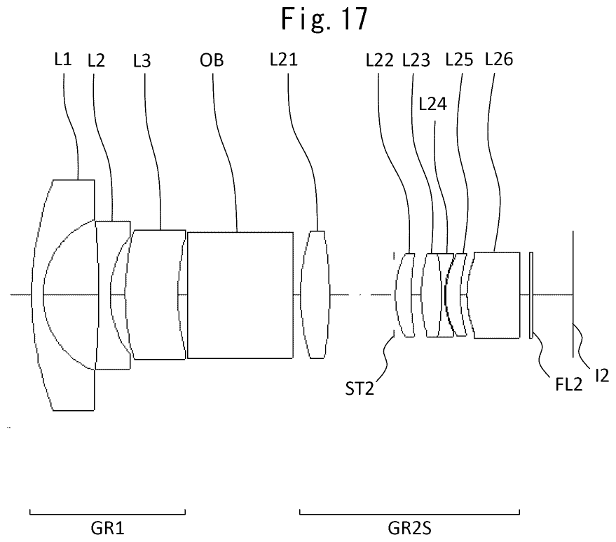

FIG. 17 is a cross-sectional view of the second optical system OS2 included in the optical system 1 of the fourth example.

The second optical system OS2 of the present example includes, in order from the object side, the meniscus-shaped negative lens L1 convex on the object side, the biconcave negative lens L2, the meniscus-shaped positive lens L3 convex on the object side, the optical path splitter OB, a biconvex positive lens L21, an aperture stop ST2, a meniscus-shaped positive lens L22 convex on the object side, a negative cemented lens composed of a biconvex positive lens L23 and a biconcave negative lens L24, a meniscus-shaped positive lens L25 convex on the object side, and a meniscus-shaped positive lens L26 convex on the object side.

An imaging device constructed from CCD, CMOS, or the like is disposed on the image plane I2.

A filter FL2 is disposed between the image plane I2 and the positive lens L26 closest to the image plane I2.

In the second optical system OS2 of the present example, the negative lenses L1 and L2 and the positive lens L3 are included in the front lens group GR1. The positive lens L21, the aperture stop ST2, the positive lens L22, the negative cemented lens composed of the positive lens L23 and the negative lens L24, and the positive lenses L25 and L26 are included in the second rear lens group GR2S.

Table 4-2 below shows specifications of the second optical system OS2 of the present example.

TABLE 4-2
[Lens specifications]

| m | r | d | n(d) | νd | |
|---|---|---|---|---|---|
| 1) | 31.56470 | | 1.190 | 1.640 | 60.19 |
| 2) | 8.14860 | | 5.800 | | |
| 3) | −75.53150 | | 1.190 | 1.618 | 63.34 |
| 4) | 9.75210 | | 1.550 | | |
| 5) | 23.57220 | | 5.500 | 1.755 | 27.57 |
| 6) | 23.35310 | | 1.000 | | |
| 7) | ∞ | 11.000 | 1.517 | 63.88 | (optical |
| | | | | | path |
| | | | | | splitter |
| | | | | | OB) |
| 8) | ∞ | 0.770 | | | |
| 9) | 20.16450 | | 3.000 | 1.700 | 48.10 |
| 10) | −37.07530 | | 6.760 | | |
| 11> | ∞ | 0.100 | | | (aperture |
| | | | | | stop ST2) |
| 12) | 9.12160 | | 1.650 | 1.651 | 56.24 |
| 13) | 23.81970 | | 1.050 | | |
| 14) | 14.35620 | | 2.100 | 1.519 | 69.89 |
| 15) | −22.90500 | | 0.350 | 1.755 | 27.57 |
| 16) | 7.95000 | | 0.100 | | |
| 17) | 7.86080 | | 1.510 | 1.620 | 60.24 |
| 18) | 12.41850 | | 0.710 | | |
| *19) | 9.06350 | | 5.500 | 1.620 | 60.24 |
| *20) | 256.56200 | | 1.000 | | |
| 21) | ∞ | 0.300 | 1.517 | | (filter |
| | | | | | FL2) |
| 22) | ∞ | 4.275 | | 63.88 | |

[Aspherical surface data]

| m | K | A4 | A6 | A8 | A10 |
|---|---|---|---|---|---|
| 19) | −1.2102 | −1.11E−04 | −3.56E−06 | −1.97E−07 | 1.67E−09 |
| 20) | −9.0000 | 5.03E−05 | −4.33E−06 | −2.03E−08 | 3.18E−10 |

[General specifications]

| | |
|---|---|
| Fno | 1.91 |
| f | 4.02 |
| TL | 56.30 |
| Y | 3.96 |
| 2ω | 116.00 |

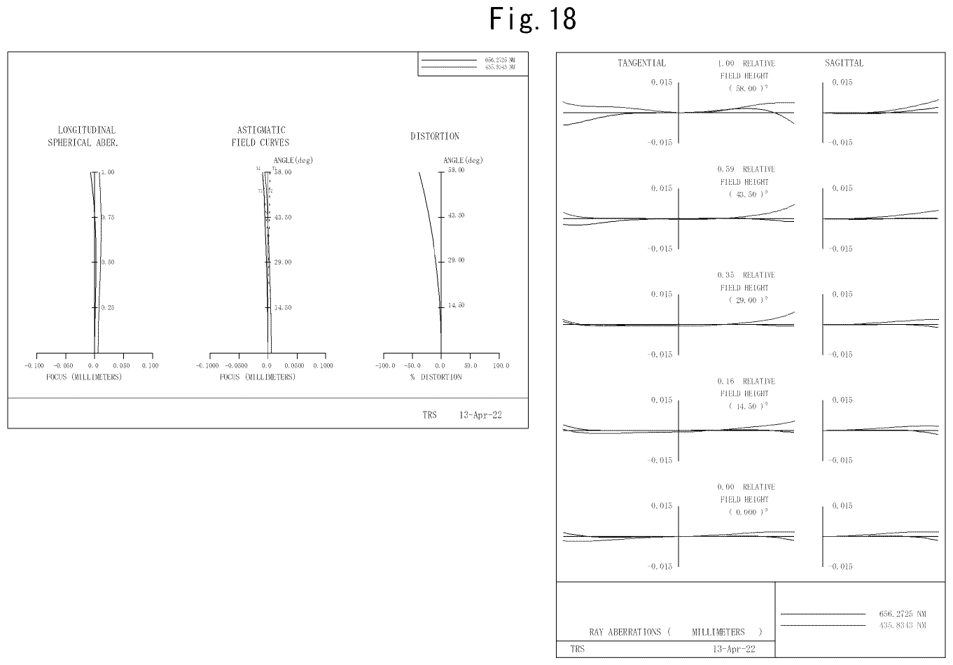

FIG. 18 shows aberrations of the second optical system OS2 included in the optical system 1 of the fourth example. The graphs of aberrations show the values at d-line and g-line.

The graphs of aberrations suggest that the second optical system OS2 of the present example corrects aberrations appropriately and has high optical performance at d-line and g-line.

### Fifth Example

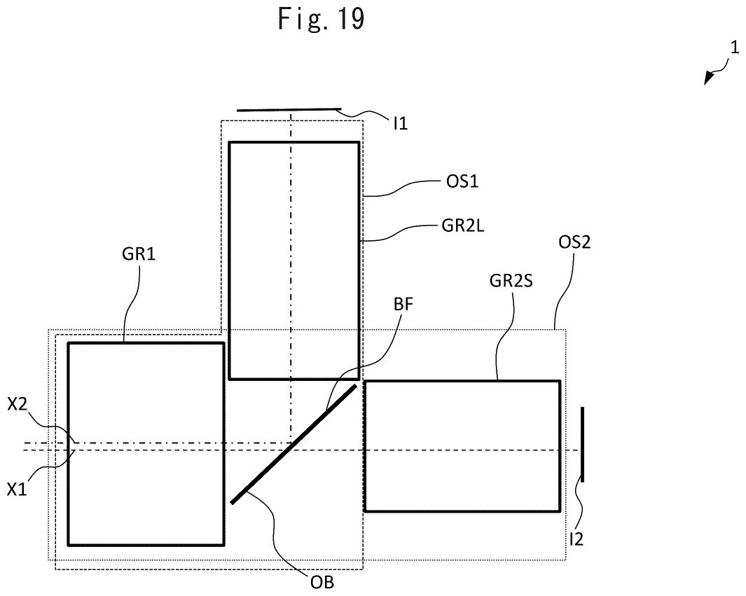

FIG. 19 schematically shows the configuration of an optical system of a fifth example.

The optical system 1 of the present example includes a first optical system OS1 including, in order from the object side, a front lens group GR1, an optical path splitter OB with a splitting plane BF, and a first rear lens group GR2L on which light that enters the front lens group GR1 and the optical path splitter OB and that is reflected by the splitting plane BF is incident. The optical system 1 of the present example also includes a second optical system OS2 including, in order from the object side, the front lens group GR1, the optical path splitter OB, and a second rear lens group GR2S on which light that enters the front lens group GR1 and the optical path splitter OB and that is transmitted through the splitting plane BF is incident. The first optical system OS1 has a greater total optical length than the second optical system OS2.

On the object side of the splitting plane BF, FIG. 19 shows the first optical axis X1 of the first optical system OS1 and the second optical axis X2 of the second optical system OS2 without overlap for illustrative purposes.

In the optical system 1 of the present example, the optical path splitter OB is a dichroic mirror with a splitting plane BF that transmits near-infrared light and that reflects visible light.

The first optical system OS1 of the present example focuses light emitted from the front lens group GR1 and reflected by the splitting plane BF and a total reflection surface TRF of the optical path splitter OB (visible light) on an image plane I1. The second optical system OS2 of the present example focuses light emitted from the front lens group GR1 and transmitted through the splitting plane BF of the optical path splitter OB (near-infrared light) on an image plane I2.

The optical system 1 of the present example can appropriately focus, of incident light, light reflected by the splitting plane BF and light transmitted through the splitting plane BF with the first optical system OS1 and the second optical system OS2, respectively.

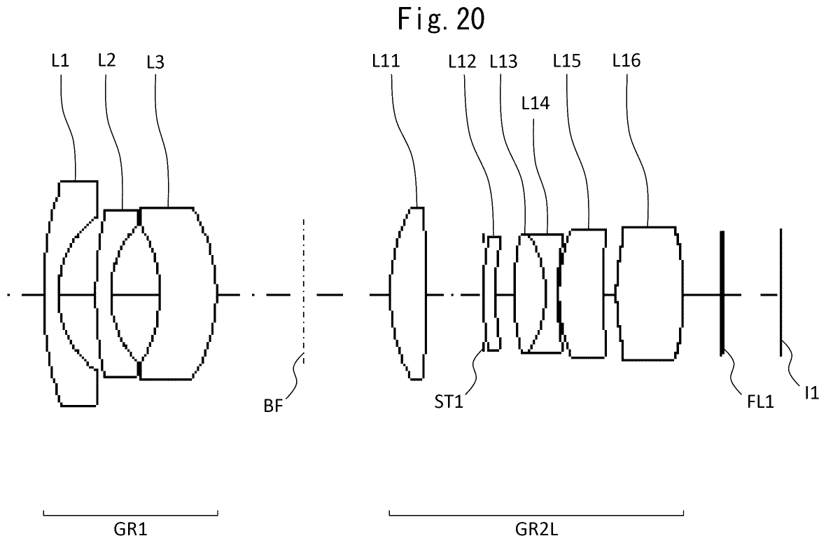

FIG. 20 is a cross-sectional view of the first optical system OS1 included in the optical system 1 of the fifth example.

The first optical system OS1 of the present example includes, in order from the object side, a meniscus-shaped negative lens L1 convex on the object side, a meniscus-shaped negative lens L2 convex on the object side, a meniscus-shaped negative lens L3 concave on the object side, an optical path splitter OB, a biconvex positive lens L11, an aperture stop ST1, a meniscus-shaped positive lens L12 convex on the object side, a negative cemented lens composed of a biconvex positive lens L13 and a biconcave negative lens L14, a meniscus-shaped positive lens L15 convex on the object side, and a biconvex positive lens L16.

An imaging device constructed from CCD, CMOS, or the like is disposed on the image plane I1.

A filter FL1 is disposed between the image plane I1 and the positive lens L16 closest to the image plane I1.

In the first optical system OS1 of the present example, the negative lenses L1, L2, and L3 are included in the front lens group GR1. The positive lens L11, the aperture stop ST1, the positive lens L12, the negative cemented lens composed of the positive lens L13 and the negative lens L14, and the positive lenses L15 and L16 are included in the first rear lens group GR2L.

Table 5-1 below shows specifications of the first optical system OS1 of the present example.

TABLE 5-1
[Lens specifications]

| m | r | d | n(d) | νd | |
|---|---|---|---|---|---|
| 1) | 29.39415 | | 1.200 | 1.700 | 48.10 |
| 2) | 7.87468 | | 3.100 | | |
| 3) | 31.19550 | | 1.200 | 1.487 | 70.32 |
| 4) | 8.16096 | | 4.050 | | |
| 5) | −10.84631 | | 4.650 | 1.744 | 44.80 |
| 6) | −13.43511 | | 7.000 | | |
| 7) | ∞ | 7.300 | | | (splitter |
| | | | | | plane BF) |
| 8) | 15.01135 | | 3.000 | 1.700 | 48.10 |
| 9) | −73.65866 | | 4.550 | | |
| 10> | ∞ | 0.100 | | | (aperture |
| | | | | | stop ST1) |
| 11) | 23.57922 | | 1.000 | 1.487 | 70.32 |
| 12) | 23.57922 | | 1.480 | | |
| 13) | 18.35557 | | 2.600 | 1.487 | 70.32 |
| 14) | −9.05030 | | 1.000 | 1.795 | 28.69 |
| 15) | 22.40141 | | 0.100 | | |
| 16) | 13.35807 | | 3.730 | 1.487 | 70.32 |
| 17) | 149.95808 | | 1.000 | | |
| *18) | 15.09709 | | 5.500 | 1.497 | 81.56 |
| *19) | −26.56453 | | 3.000 | | |
| 20) | ∞ | 0.300 | 1.517 | 63.88 | (filter FL1) |
| 21) | ∞ | 4.789 | | | |

[Aspherical surface data]

| m | K | A4 | A6 | A8 | A10 |
|---|---|---|---|---|---|
| 18) | 1.7852 | −3.47E−04 | −3.83E−06 | 8.53E−08 | −1.80E−09 |
| 19) | 1.7594 | −1.61E−04 | −1.61E−06 | 4.22E−09 | 5.09E−10 |

[General specifications]

| | |
|---|---|
| Fno | 2.05 |
| f | 5.10 |
| TL | 60.55 |
| Y | 4.00 |
| 2ω | 92.00 |

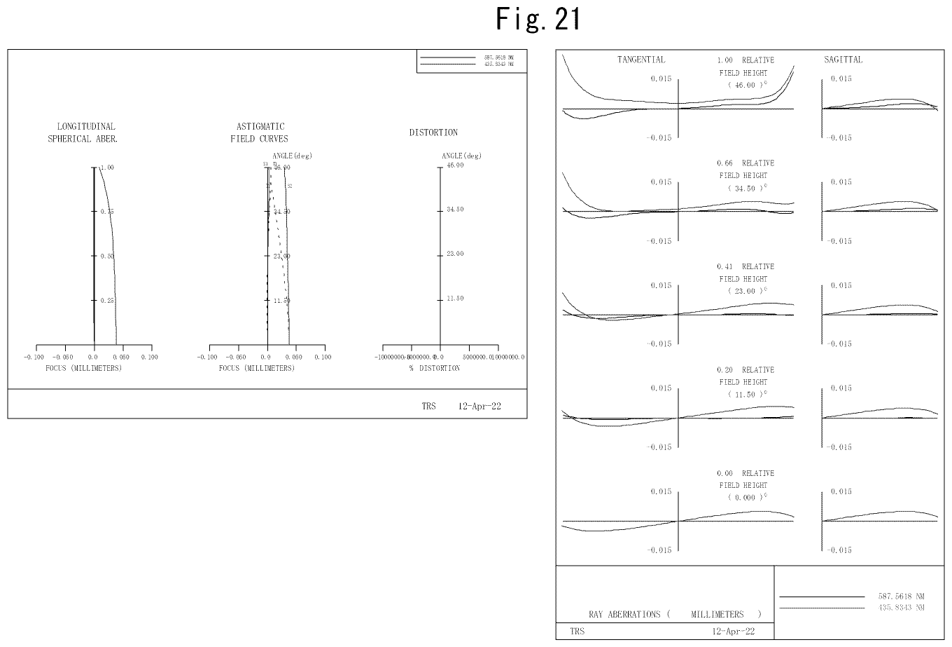

FIG. 21 shows aberrations of the first optical system OS1 included in the optical system 1 of the fifth example. The graphs of aberrations show the values at d-line and g-line.

The graphs of aberrations suggest that the first optical system OS1 of the present example corrects aberrations appropriately and has high optical performance at d-line and g-line.

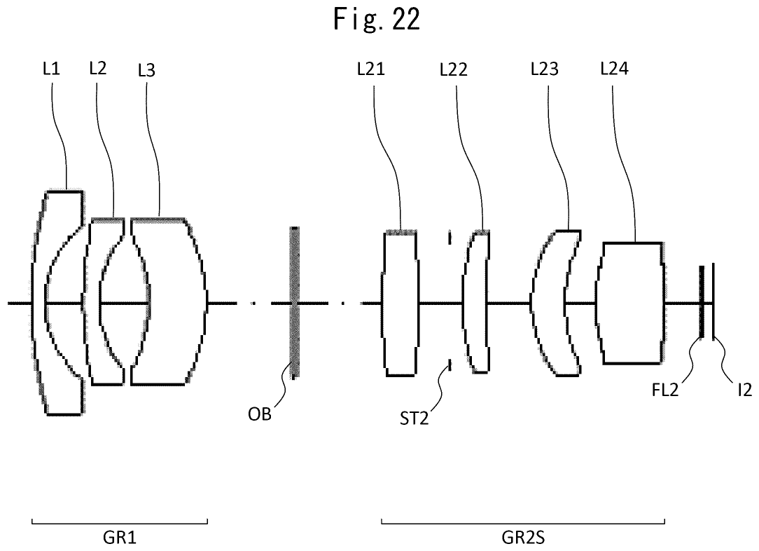

FIG. 22 is a cross-sectional view of the second optical system OS2 included in the optical system 1 of the fifth example.

The second optical system OS2 of the present example includes, in order from the object side, the meniscus-shaped negative lens L1 convex on the object side, the meniscus-shaped negative lens L2 convex on the object side, the meniscus-shaped negative lens L3 concave on the object side, the optical path splitter OB, a biconvex positive lens L21, an aperture stop ST2, a meniscus-shaped positive lens L22 convex on the object side, a meniscus-shaped positive lens L23 convex on the object side, and a biconvex positive lens L24.

An imaging device constructed from CCD, CMOS, or the like is disposed on the image plane I2.

In the second optical system OS2 of the present example, the negative lenses L1, L2, and L3 are included in the front lens group GR1. The positive lens L21, the aperture stop ST2, and the positive lenses L22, L23, and L24 are included in the second rear lens group GR2S.

Table 5-2 below shows specifications of the second optical system OS2 of the present example.

TABLE 5-2
[Lens specifications]

| m | r | d | n(d) | νd | ns | |
|---|---|---|---|---|---|---|
| 1) | 29.39415 | | 1.200 | 1.700 | 48.10 | 1.631 |
| 2) | 7.87468 | | 3.100 | | | |
| 3) | 31.19550 | | 1.200 | 1.487 | 70.32 | 1.610 |
| 4) | 8.16096 | | 4.050 | | | |
| 5) | −10.84631 | | 4.650 | 1.744 | 44.80 | 1.735 |
| 6) | −13.43511 | | 7.000 | | | |
| 7) | ∞ | 0.300 | 1.517 | 63.88 | 1.510 | (splitting |
| | | | | | | plane BF) |
| 8) | ∞ | 7.000 | | | | |
| 9) | 56.18678 | | 2.900 | 1.519 | 69.89 | 1.512 |
| 10) | −76.02105 | | 2.500 | | | |
| 11> | ∞ | 1.000 | | | | (aperture |
| | | | | | | stop ST2) |
| 12) | 15.05046 | | 2.000 | 1.762 | 40.11 | 1.747 |
| 13) | 47.09491 | | 3.640 | | | |
| 14) | 9.36251 | | 2.750 | 1.755 | 27.57 | 1.735 |
| 15) | 12.22463 | | 2.475 | | | |
| *16) | 11.58211 | | 5.500 | 1.689 | 31.16 | 1.672 |
| *17) | −224.86865 | | 3.000 | | | |
| 18) | ∞ | 0.300 | 1.517 | 63.88 | 1.510 | (filter FL2) |
| 19) | ∞ | 0.455 | | | | |

[Aspherical surface data]

| m | K | A4 | A6 | A8 | A10 |
|---|---|---|---|---|---|
| 16) | −6.9904 | 1.97E−04 | −1.78E−05 | 2.75E−07 | −8.03E−10 |
| 17) | −9.0000 | −2.93E−04 | 6.27E−07 | 4.02E−07 | −2.73E−09 |

[General specifications]

| | |
|---|---|
| Fno | 1.27 |
| f | 2.82 |
| TL | 54.92 |
| Y | 2.29 |
| 2ω | 92.00 |

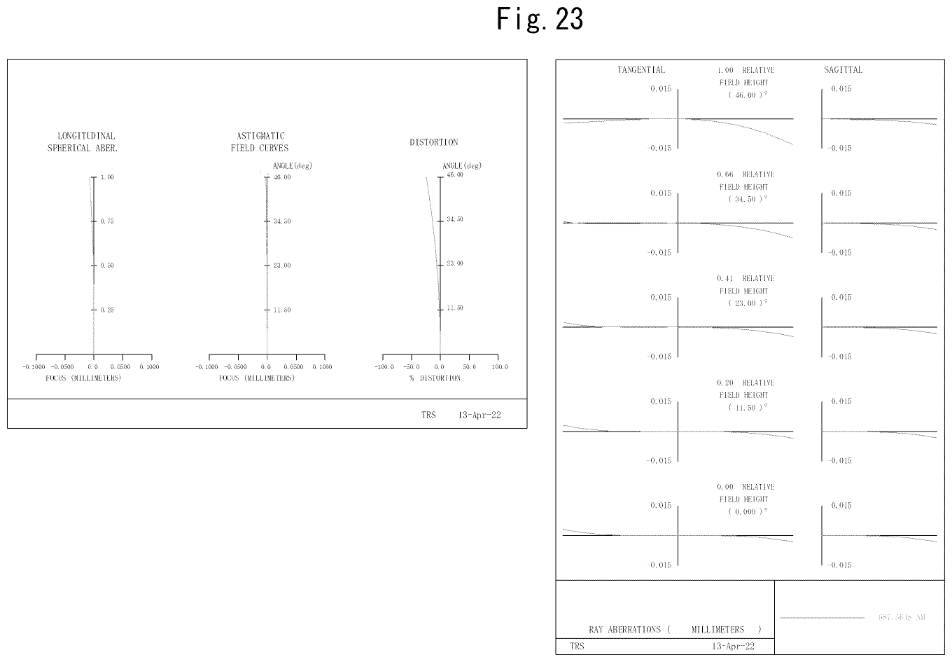

FIG. 23 shows aberrations of the second optical system OS2 included in the optical system 1 of the fifth example. The graphs of aberrations show the values at s-line.

The graphs of aberrations suggest that the second optical system OS2 of the present example corrects aberrations appropriately and has high optical performance at s-line.

An optical system that appropriately focuses, of incident light, light transmitted through the splitting plane and light reflected by the splitting plane can be achieved according to the above examples.

Values for the conditional expressions of the examples are listed below.

f(L) is the focal length of the first optical system OS1; f(S) is the focal length of the second optical system OS2. TL(L) is the total optical length of the first optical system OS1; TL(S) is the total optical length of the second optical system OS2.

f(fL) is the longer of the focal lengths of the first and second optical systems OS1 and OS2; f(fS) is the shorter of the focal lengths of the first and second optical systems OS1 and OS2.

f(gr1) is the combined focal length of the front lens group GR1. f(gr1n) is the combined focal length of a negative lens disposed closest to the object side of negative lenses in the front lens group GR1 and one or more negative lenses disposed next to the negative lens on the image plane side. f(gr1p) is the combined focal length of a positive lens disposed closest to the object side of positive lenses in the front lens group GR1 and one or more positive lenses disposed next to the positive lens on the image plane side. T(gr1) is the distance on the optical axis from a lens surface closest to the object side in the front lens group GR1 to a lens surface closest to an image plane in the front lens group GR1.

T(pL) is the length on the optical axis of the prism in the first optical system OS1; T(pS) is the length on the optical axis of the prism in the second optical system OS2. T(pfL) is the length on the optical axis of the prism in the first or second optical system OS1 or OS2 with a longer focal length; T(pfS) is the length on the optical axis of the prism in the first or second optical system OS1 or OS2 with a shorter focal length.

f(gr2L) is the combined focal length of lenses in the first rear lens group GR2L closer to the image plane than the aperture stop ST1; f(gr2S) is the combined focal length of lenses in the second rear lens group GR2S closer to the image plane than the aperture stop ST2.

f(lL) is the focal length of a lens closest to the image plane in the first rear lens group GR2L; f(lS) is the focal length of a lens closest to the image plane in the second rear lens group GR2S.

Nave(s) is an average of the refractive indices at s-line of negative lenses in the front lens group GR1. 2ωL is the total field angle of the first optical system OS1; 2ωS is the total field angle of the second optical system OS2.

The values listed in [Values for conditional expressions] are those at d-line except for those of conditional expression (16), which are the values at s-line.

### [Values for Conditional Expressions]

### Examples

| Conditional expressions | | First | Second | Third | Fourth | Fifth |
|---|---|---|---|---|---|---|
| (1) −f(gr1n)/f(L) | | 2.771 | 1.786 | 2.871 | 2.855 | 1.857 |
| (2) T(pL)/T(pS) | | 2.955 | 2.708 | 2.765 | 1.000 | — |
| (3) −f(gr1n)/f(S) | | 1.562 | 3.249 | 1.708 | 1.608 | 3.353 |
| (26) TL(L)/TL(S) | | 1.202 | 1.188 | 1.507 | 1.096 | 1.103 |
| (5) −f(gr1n)/f(gr1p) | | 0.109 | 0.089 | 0.068 | 0.019 | — |
| (6) f(gr2S)/−f(gr1) | | 1.368 | 0.999 | 1.809 | 2.415 | 1.158 |
| (7) f(gr2L)/−f(gr1) | | 1.496 | 3.164 | 1.750 | 1.620 | 2.598 |
| (8) f(lS)/−f(gr1n) | | 3.943 | 1.764 | 4.191 | 2.320 | 1.705 |
| (9) f(lL)/−f(gr1n) | | 3.597 | 2.774 | 3.864 | 2.583 | 2.140 |
| (10) f(gr2S)/f(S) | | 2.870 | 3.631 | 3.565 | 3.628 | 3.883 |
| (11) f(gr2L)/f(L) | | 5.567 | 6.318 | 5.798 | 4.320 | 4.824 |
| (12) T(pS)/f(S) | | 2.206 | 4.338 | 3.449 | 2.733 | — |
| (13) T(pL)/f(L) | | 11.559 | 6.456 | 16.030 | 4.851 | — |
| (14) T(gr1)/f(S) | | 3.657 | 3.958 | 2.876 | 3.784 | 5.031 |
| (15) T(gr1)/f(L) | | 6.487 | 2.175 | 4.835 | 6.717 | 2.786 |
| (16) Nave(s) | 1.610 | 1.620 | 1.553 | 1.620 | 1.658 | |
| (17) f(lS)/f(lL) | 1.096 | 0.636 | 1.085 | 0.898 | 0.797 | |
| (18) T(gr1)/−f(gr1) | | 1.743 | 1.089 | 1.459 | 2.519 | 1.500 |
| (19) T(gr1)/−f(gr1n) | | 2.341 | 1.218 | 1.684 | 2.353 | 1.500 |
| (20) T(gr1)/f(fL) | | 3.657 | 2.175 | 2.876 | 3.784 | 2.786 |
| (21) T(pfL)/f(fL) | | 2.206 | 6.456 | 3.449 | 2.733 | — |
| (22) T(gr1)/f(fS) | | 6.487 | 3.958 | 4.835 | 6.717 | 5.031 |
| (23) T(pfS)/f(fS) | | 11.559 | 4.338 | 16.030 | 4.851 | — |
| (24) 2ωL | 92.00 | 92.00 | 92.00 | 92.00 | 92.00 | |
| (25) 2ωS | 92.00 | 92.00 | 92.00 | 116.00 | 92.00 | |

The above examples are specific examples of the present invention, and the present invention is not limited thereto.

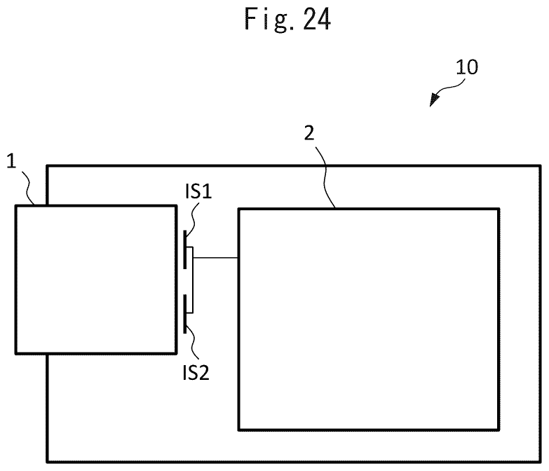

Next, an optical apparatus including the optical system 1 of the present embodiment will be described with reference to FIG. 24. FIG. 24 schematically shows an optical apparatus 10 including the optical system 1 of the present embodiment.

The optical apparatus 10 includes the optical system 1 of the first example, an information processor 2, a first imaging unit IS1, and a second imaging unit IS2.

The first imaging unit IS1 and the second imaging unit IS2 each include an imaging device constructed from CCD, CMOS, or the like. In the optical apparatus 10, the optical system 1 appropriately focuses, of incident light, light reflected by the splitting plane BF and light transmitted through the splitting plane BF with the first optical system OS1 and the second optical system OS2, respectively. The first imaging unit IS1 and the second imaging unit IS2 are disposed on the image plane I1 of the first optical system OS1 and the image plane I2 of the second optical system OS2, respectively, and output data corresponding to incident light. The information processor 2 executes processing with data outputted by the first imaging unit IS1 and the second imaging unit IS2.

For example, the optical system 1 included in the optical apparatus 10 includes a splitting plane BF that transmits visible light and that reflects near-infrared light, out of light that enters the optical system 1 from an object. The first optical system OS1 and the second optical system OS2 included in the optical system 1 focus near-infrared light and visible light, respectively. The information processor 2 included in the optical apparatus 10 detects the distance to the object from an image formed by the first optical system OS1. The information processor 2 included in the optical apparatus 10 also detects the outward appearance of the object by generating image data from an image formed by the second optical system OS2.

In this way, the optical apparatus 10 can appropriately focus, of incident light, light transmitted through the splitting plane BF and light reflected by the splitting plane BF, and execute processing with their respective images.

The optical apparatus 10 may include an optical system in which a first optical system OS1 and a second optical system OS2 focus visible light and near-infrared light, respectively, like the optical system 1 of the second example. In this case, the information processor 2 detects the outward appearance of an object by generating image data from an image formed by the first optical system OS1, and detects the distance to the object from an image formed by the second optical system OS2.

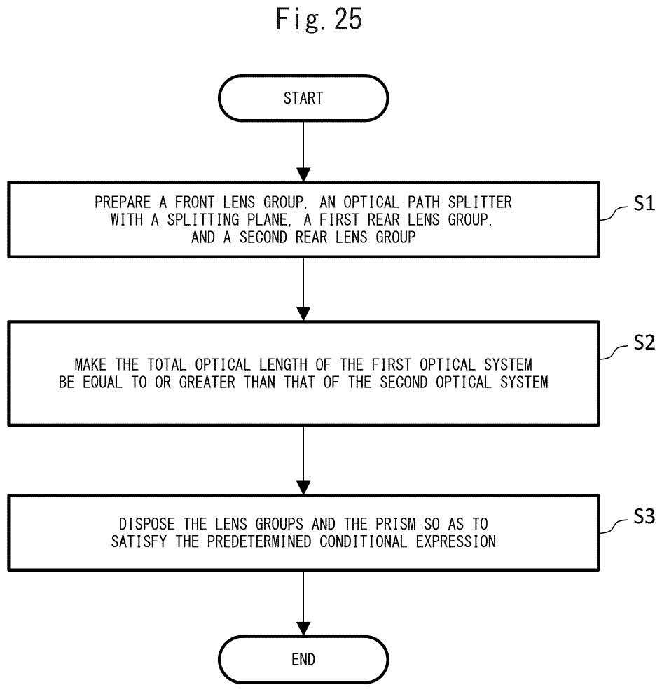

Finally, a method for manufacturing the optical system 1 of the present embodiment will be outlined with reference to FIG. 25. FIG. 25 is a flowchart outlining a method for manufacturing the optical system 1 of the present embodiment.

The method for manufacturing the optical system 1 of the present embodiment shown in FIG. 25 includes steps S1, S2, and S3 below.

Step S1: a front lens group GR1, an optical path splitter OB with a splitting plane BF, a first rear lens group GR2L, and a second rear lens group GR2S are prepared.

Step S2: the total optical length of the first optical system OS1 is made to be equal to or greater than that of the second optical system OS2.

Step S3: the lens groups and the optical path splitter OB are disposed so as to satisfy the following conditional expression.

$$0.50 < T ( gr 1 ) / ( - f ( gr 1 ) ) < 4.50 \qquad ( 18 )$$

where
T(gr1): the distance on the optical axis from a lens surface closest to the object side in the front lens group to a lens surface closest to an image plane in the front lens group
f(gr1): the combined focal length of the front lens group

In a modified example, steps S1A and S3A below may be performed instead of steps S1 and S3 in the method for manufacturing the optical system 1 of the present embodiment shown in FIG. 25.

Step S1A: a front lens group GR1, a prism with a splitting plane BF, a first rear lens group GR2L, and a second rear lens group GR2S are prepared.

Step S3A: the lens groups and the prism are disposed so as to satisfy the following conditional expressions.

$$1.10 < T ( gr 1 ) / f ( fL ) < 5 \text{.20} \qquad ( 20 )$$

$$1. < T ( pfL ) / f ( fL ) < 11.50 \qquad ( 21 )$$

where
T(gr1): the distance on the optical axis from a lens surface closest to the object side in the front lens group to a lens surface closest to an image plane in the front lens group
f(fL): the longer of the focal lengths of the first and second optical systems
T(pfL): the length on the optical axis of the prism in the first or second optical system with a longer focal length

In another modified example, step S3B below may be performed instead of step S3A in the manufacturing method of the above modified example.

Step S3B: the lens groups and the prism are disposed so as to satisfy the following conditional expressions.

$$2.50 < T ( gr 1 ) / f ( fS ) < 9 \text{.50} \qquad ( 22 )$$

$$3. < T ( pfS ) / f ( fS ) < 20.00 \qquad ( 23 )$$

where
T(gr1): the distance on the optical axis from a lens surface closest to the object side in the front lens group to a lens surface closest to an image plane in the front lens group
f(fS): the shorter of the focal lengths of the first and second optical systems
T(pfS): the length on the optical axis of the prism in the first or second optical system with a shorter focal length

An optical system that appropriately focuses, of incident light, light transmitted through the splitting plane and light reflected by the splitting plane can be manufactured by the methods for manufacturing an optical system of the present embodiment.

In the optical system of the present embodiment, lens surfaces may be spherical, plane, or aspherical surfaces. Spherical or plane lens surfaces are preferable because they facilitate lens machining, assembling, and adjustment and prevent a decrease in optical performance caused by errors in machining, assembling, and adjustment and because depiction performance does not decrease much when the image plane is shifted.

An aspherical lens surface may be formed by grinding glass or glass molding with a mold having an aspherical shape, or formed on the surface of resin bonded on a glass surface. In the optical system of the present embodiment, lens surfaces may be diffractive surfaces, and lenses may be graded index lenses (GRIN lenses) or plastic lenses.

The lens surfaces of the lenses constituting the optical system of the present embodiment may be covered with antireflection coating having high transmittance in a wide wavelength range. This reduces flares and ghosts, and enables achieving optical performance with high contrast.

The optical system of the present embodiment may use a lens frame or the like as a substitute for an aperture stop without including a separate member serving as an aperture stop.

Regarding the above embodiment, the following notes will be further disclosed.

### [Note 1]

An optical system comprising:
a first optical system including, in order from an object side, a front lens group, a prism with a splitting plane that transmits a first part of incident light and that reflects at least a second part of the incident light different from the first part, and a first rear lens group on which one of the transmitted light and the reflected light is incident; and
a second optical system including, in order from the object side, the front lens group, the prism, and a second rear lens group on which the other of the transmitted light and the reflected light is incident,
the first optical system having a greater total optical length than the second optical system,
the optical system satisfying the following conditional expressions.

$$2.5 < T ( gr 1 ) / f ( fS ) < 9 \text{.50}$$

$$3. < T ( pfS ) / f ( fS ) < 20.00$$

where
T(gr1): the distance on the optical axis from a lens surface closest to the object side in the front lens group to a lens surface closest to an image plane in the front lens group
f(fS): the shorter of the focal lengths of the first and second optical systems
T(pfS): the length on the optical axis of the prism in the first or second optical system with a shorter focal length

### [Note 2]

The optical system according to note 1, wherein the following conditional expression is satisfied.

$$1.5 < Nave ( s ) < 1.90$$

where
Nave(s): an average of the refractive indices at s-line of negative lenses in the front lens group

### [Note 3]

The optical system according to note 1 or 2, wherein the front lens group has negative refractive power.

### [Note 4]

The optical system according to any one of notes 1-3, wherein the front lens group includes one or more positive lenses and one or more negative lenses.

### [Note 5]

The optical system according to any one of notes 1-4, wherein the first and second optical systems each include a positive lens closest to the image plane.

### [Note 6]

The optical system according to any one of notes 1-5, wherein the following conditional expressions are satisfied.

80.0 degrees<2ωL

80.0 degrees<2ωS

where
2ωL: the total field angle of the first optical system
2ωS: the total field angle of the second optical system

It should be noted that those skilled in the art can make various changes, substitutions, and modifications without departing from the spirit and scope of the present disclosure.

1. An optical system comprising:
a first optical system including, in order from an object side, a front lens group, an optical path splitter with a splitting plane that transmits a first part of incident light and that reflects at least a second part of the incident light different from the first part, and a first rear lens group on which one of the transmitted light and the reflected light is incident; and
a second optical system including, in order from the object side, the front lens group, the optical path splitter, and a second rear lens group on which the other of the transmitted light and the reflected light is incident,
the optical system satisfying the following conditional expression.
$$0.5 < T ( gr 1 ) / ( - f ( gr 1 ) ) < 4.50$$
where
T(gr1): the distance on the optical axis from a lens surface closest to the object side in the front lens group to a lens surface closest to an image plane in the front lens group
f(gr1): the combined focal length of the front lens group

2. The optical system according to claim 1, wherein the following conditional expression is satisfied.
$$0.8 < T ( gr 1 ) / ( - f ( gr 1 n ) ) < 4.6$$
where
f(gr1n): the combined focal length of a negative lens disposed closest to the object side of negative lenses in the front lens group and one or more negative lenses disposed next to the negative lens on the image plane side

3. The optical system according to claim 1, wherein the following conditional expression is satisfied.
$$1. < TL ( L ) / TL ( s ) < 3.50$$
where
TL(L): the total optical length of the first optical system
TL(S): the total optical length of the second optical system

4. An optical system comprising:
a first optical system including, in order from an object side, a front lens group, a prism with a splitting plane that transmits a first part of incident light and that reflects at least a second part of the incident light different from the first part, and a first rear lens group on which one of the transmitted light and the reflected light is incident; and
a second optical system including, in order from the object side, the front lens group, the prism, and a second rear lens group on which the other of the transmitted light and the reflected light is incident,
the first optical system having a greater total optical length than the second optical system,
the optical system satisfying the following conditional expressions.
$$1.1 < T ( gr 1 ) / f ( fL ) < 5.2$$
$$1. < T ( pfL ) / f ( fL ) < 11.50$$
where
T(gr1): the distance on the optical axis from a lens surface closest to the object side in the front lens group to a lens surface closest to an image plane in the front lens group
f(fL): the longer of the focal lengths of the first and second optical systems
T(pfL): the length on the optical axis of the prism in the first or second optical system with a longer focal length

5. The optical system according to claim 4, wherein the following conditional expression is satisfied.
$$1.1 < T ( pL ) / T ( pS ) < 5.50$$
where
T(pL): the length on the optical axis of the prism in the first optical system
T(pS): the length on the optical axis of the prism in the second optical system

6. The optical system according to claim 4, wherein the following conditional expression is satisfied.
$$1.2 < T ( pS ) / f ( S ) < 6.4$$
where
T(pS): the length on the optical axis of the prism in the second optical system
f(S): the focal length of the second optical system

7. The optical system according to claim 4, wherein the following conditional expression is satisfied.
$$2.4 < T ( pL ) / f ( L ) < 20.5$$
where
T(pL): the length on the optical axis of the prism in the first optical system
f(L): the focal length of the first optical system

8. The optical system according to claim 3, wherein the following conditional expression is satisfied.
$$1.4 < T ( gr 1 ) / f ( S ) < 6.9$$
where
f(S): the focal length of the second optical system

9. The optical system according to claim 3, wherein the following conditional expression is satisfied.
$$1. < T ( gr 1 ) / f ( L ) < 9.8$$
where
f(L): the focal length of the first optical system

10. The optical system according to claim 3, wherein the following conditional expression is satisfied.
$$0.8 < - f ( gr 1 n ) / f ( L ) < 4.3$$
where
f(gr1n): the combined focal length of a negative lens disposed closest to the object side of negative lenses in the front lens group and one or more negative lenses disposed next to the negative lens on the image plane side
f(L): the focal length of the first optical system

11. The optical system according to claim 3, wherein the following conditional expression is satisfied.
$$0.5 < - f ( gr 1 n ) / f ( S ) < 4.4$$
where
f(gr1n): the combined focal length of a negative lens disposed closest to the object side of negative lenses in the front lens group and one or more negative lenses disposed next to the negative lens on the image plane side
f(S): the focal length of the second optical system

12. The optical system according to claim 3, wherein the second rear lens group includes an aperture stop, and the following conditional expression is satisfied.
$$0.5 < f ( gr 2 S ) / ( - f ( gr 1 ) ) < 3.4$$
where
f(gr2S): the combined focal length of lenses in the second rear lens group closer to the image plane than the aperture stop
f(gr1): the combined focal length of the front lens group

13. The optical system according to claim 3, wherein the first rear lens group includes an aperture stop, and the following conditional expression is satisfied.
$$0.4 < f ( gr 2 L ) / ( - f ( gr 1 ) ) < 4.2$$
where
f(gr2L): the combined focal length of lenses in the first rear lens group closer to the image plane than the aperture stop
f(gr1): the combined focal length of the front lens group

14. The optical system according to claim 3, wherein the following conditional expression is satisfied.
$$0.7 < f ( 1 S ) / ( - f ( gr 1 n ) ) < 5.9$$
where
f(lS): the focal length of a lens closest to the image plane in the second rear lens group
f(gr1n): the combined focal length of a negative lens disposed closest to the object side of negative lenses in the front lens group and one or more negative lenses disposed next to the negative lens on the image plane side

15. The optical system according to claim 3, wherein the following conditional expression is satisfied.
$$1.5 < f ( 1 L ) / ( - f ( gr 1 n ) ) < 7.7$$
where
f(lL): the focal length of a lens closest to the image plane in the first rear lens group
f(gr1n): the combined focal length of a negative lens disposed closest to the object side of negative lenses in the front lens group and one or more negative lenses disposed next to the negative lens on the image plane side

16. The optical system according to claim 3, wherein the second rear lens group includes an aperture stop, and the following conditional expression is satisfied.
$$1.6 < f ( gr 2 S ) / f ( S ) < 5.6$$
where
f(gr2S): the combined focal length of lenses in the second rear lens group closer to the image plane than the aperture stop
f(S): the focal length of the second optical system

17. The optical system according to claim 3, wherein the first rear lens group includes an aperture stop, and the following conditional expression is satisfied.
$$2.3 < f ( gr 2 L ) / f ( L ) < 8.8$$
where
f(gr2L): the combined focal length of lenses in the first rear lens group closer to the image plane than the aperture stop
f(L): the focal length of the first optical system

18. The optical system according to claim 3, wherein the following conditional expression is satisfied.
$$0.23 < f ( 1 S ) / f ( 1 L ) < 1.5$$
where
f(lS): the focal length of a lens closest to the image plane in the second rear lens group
f(lL): the focal length of a lens closest to the image plane in the first rear lens group

19. The optical system according to claim 1, wherein the following conditional expression is satisfied.
$$0.01 < - f ( gr 1 n ) / f ( gr 1 p ) < 0.21$$
where
f(gr1n): the combined focal length of a negative lens disposed closest to the object side of negative lenses in the front lens group and one or more negative lenses disposed next to the negative lens on the image plane side
f(gr1p): the combined focal length of a positive lens disposed closest to the object side of positive lenses in the front lens group and one or more positive lenses disposed next to the positive lens on the image plane side

20. The optical system according to claim 1, wherein of the transmitted light and the reflected light, one is visible light and the other is near-infrared light; of the first and second optical systems, an optical system using the visible light from the splitting plane to the image plane includes a cemented lens and an optical system using the near-infrared light from the splitting plane to the image plane consists of only single lenses.

21. An optical apparatus comprising the optical system according to claim 1.

22. A method for manufacturing an optical system comprising:
a first optical system including, in order from an object side, a front lens group, an optical path splitter with a splitting plane that transmits a first part of incident light and that reflects at least a second part of the incident light different from the first part, and a first rear lens group on which one of the transmitted light and the reflected light is incident; and
a second optical system including, in order from the object side, the front lens group, the optical path splitter, and a second rear lens group on which the other of the transmitted light and the reflected light is incident,
the total optical length of the first optical system being equal to or greater than the total optical length of the second optical system,
the method comprising disposing the lens groups and the optical path splitter so as to satisfy the following conditional expression.
$$0.5 < T ( gr 1 ) / ( - f ( gr 1 ) ) < 4.5$$
where
T(gr1): the distance on the optical axis from a lens surface closest to the object side in the front lens group to a lens surface closest to an image plane in the front lens group
f(gr1): the combined focal length of the front lens group
